(19) United States
(12) Patent Application Publication
(10) Pub. No.: US 2017/0259433 A1
(43) Pub. Date: Sep. 14, 2017

(54) ROBOT CONTROL DEVICE, INFORMATION PROCESSING DEVICE, AND ROBOT SYSTEM

(71) Applicant: Seiko Epson Corporation, Tokyo (JP)

(72) Inventors: Kaoru TAKEUCHI, Azumino (JP); Yasuhiro SHIMODAIRA, Matsumoto (JP)

(21) Appl. No.: 15/455,460

(22) Filed: Mar. 10, 2017

(30) Foreign Application Priority Data
Mar. 11, 2016 (JP) 2016-047951
Mar. 14, 2016 (JP) 2016-049271

(51) Int. Cl. B25J 13/08; B25J 9/00

(52) U.S. Cl. CPC B25J 13/085; B25J 9/0081

(57) ABSTRACT

A robot control device includes a robot control section that controls a robot. The robot control device outputs, to another device, second information associated with first information indicating operation being executed by the robot control section, the operation being operation for causing the robot to perform work.

### BACKGROUND

1. Technical Field

The present invention relates to a robot control device, an information processing device, and a robot system.

2. Related Art

Researches and developments of a technique for acquiring information concerning an operation state of a robot have been performed.

Concerning the technique, there has been known a robot control device that converts a given macro into element commands corresponding to element motions of a robot and sequentially executes the element commands to control the operation of the robot, detects physical quantities representing an operation state of the robot, records the detected physical quantities as first information and records, in association with the first information, a name of a macro involved in the operation of the robot at an output point in time of the first information, and outputs the first information and second information associated with the first information as one kind of united information (see, for example, JP-A-10-260710 (Patent Literature 1)).

Concerning the technique, there has been known a robot teaching system that measures, with a force sensor, a force applied to an end effector, generates a teaching operation screen including guidance information for a teacher, adjusts, on the basis of a designated value of the teacher input to the teaching operation screen and a measured value measured by the force sensor, parameters for generation of a job for defining an operation command in causing the robot to perform predetermined work including content for correcting the operation of the robot, and generates a job on which the adjusted parameters are reflected (see, for example, JP-A-2014-128857 (Patent Literature 2)).

However, the control device disclosed in Patent Literature 1 cannot record and output a correspondence relation between the physical quantities representing the operation state of the robot and the executed element commands. It is sometimes difficult to specify an element command executed by the control device when the robot performs an unintended motion.

In the robot teaching system disclosed in Patent Literature 2, the parameters adjusted by the robot teaching system sometimes do not coincide with parameters desired by the user. The user sometimes cannot cause the robot to perform a desired motion.

### SUMMARY

An advantage of some aspects of the invention is to solve at least a part of the problems described above, and the invention can be implemented as the following aspects or application examples.

An aspect of the invention is directed to a robot control device that operates a robot. The robot control device outputs, to another device, second information associated with first information indicating operation being executed by the robot control device, the operation being operation for causing the robot to perform work.

With this configuration, the robot control device outputs, to the other device, the second information associated with the first information indicating the operation being executed by the robot control device, the operation being the operation for causing the robot to perform work. Consequently, the robot control device can perform, with the other device, storage and display of the second information associated with the first information indicating the operation being executed by the robot control device, the operation being the operation for causing the robot to perform work.

In another aspect of the invention, in the robot control device, the second information may include information indicating a control amount for controlling the robot.

With this configuration, the robot control device outputs, to the other device, the second information associated with the first information, the second information including the information indicating the control amount for controlling the robot. Consequently, the robot control device can perform, with the other device, storage and display of the second information associated with the first information, the second information including the information indicating the control amount for controlling the robot.

In another aspect of the invention, in the robot control device, the second information may include information indicating a physical quantity representing an operation state of the robot.

With this configuration, the robot control device outputs, to the other device, the second information associated with the first information, the second information including the information indicating the physical quantity representing the operation state of the robot. Consequently, the robot control device can perform, with the other device, storage and display of the second information associated with the first information, the second information including the information indicating the physical quantity representing the operation state of the robot.

Another aspect of the invention is directed to an information processing device that acquires the second information from the robot control device and causes a display section to display the acquired second information and the first information associated with the second information.

With this configuration, the information processing device acquires the second information associated with the first information from the robot control device and causes the display section to display the acquired second information and the first information associated with the second information. Consequently, the information processing device can visually provide a user with the second information and the first information associated with the second information.

In another aspect of the invention, in the information processing device, the information processing device may cause the display section to display a part of the second information, the part being selected from the second information on the basis of operation received from a user.

With this configuration, the information processing device causes the display section to display a part of the second information, the part being selected from the second information on the basis of the operation received from the user. Consequently, the information processing device can visually provide the user with a part desired by the user in the part of the second information.

In another aspect of the invention, in the information processing device, the information processing device may store, in a storing section, history information indicating a history of the second information acquired from the robot control device and cause the display section to display a part of the history information, the part being selected from the history information on the basis of operation received from a user.

With this configuration, the information processing device stores, in the storing section, the history information indicating the history of the second information acquired from the robot control device and causes the display section to display a part of the history information, the part being selected from the history information on the basis of the operation received from the user. Consequently, the information processing device can visually provide the user with a part of the stored history information, the part being desired by the user.

In another aspect of the invention, in the information processing device, the second information may include information indicating corrected change amounts, which are amounts for changing a position and a posture of a control point of a robot through force control, and the information processing device may select, on the basis of operation received from a user, the first information associated with the second information including the information out of a plurality of kinds of the first information and display, on the display section, at least a part of the second information associated with the selected first information.

With this configuration, the information processing device selects, on the basis of the operation received from the user, the first information associated with the second information including the information indicating the corrected change amounts, which are the amounts for changing the position and the posture of the control point of the robot through the force control, out of the plurality of kinds of first information and displays, on the display section, at least a part of the second information associated with the selected first information. Consequently, the information processing device can visually provide the user with at least a part of the second information including the information indicating the corrected change amounts, which are the amounts for changing the position and the posture of the control point of the robot through the force control, the part being desired by the user.

Another aspect of the invention is directed to a robot system including: the robot control device described above; the information processing device described above; and a robot controlled by the robot control device.

With this configuration, the robot system outputs, to another device, second information associated with first information indicating operation being executed by the robot control device, the operation being operation for causing the robot to perform work. Consequently, the robot system can perform, with the other device, storage and display of the second information associated with the first information indicating the operation being executed by the robot control device, the operation being the operation for causing the robot to perform work.

As explained above, the robot control device and the robot system output, to the other device, the second information associated with the first information indicating the operation being executed by the robot control device, the operation being the operation for causing the robot to perform work. Consequently, the robot control device and the robot system can perform, with the other device, storage and display of the second information associated with the first information indicating the operation being executed by the robot control device, the operation being the operation for causing the robot to perform work.

The information processing device acquires the second information associated with the first information from the robot control device and causes the display section to display the acquired second information and the first information associated with the second information. Consequently, the information processing device can visually provide the user with the second information and the first information associated with the second information.

Another aspect of the invention is directed to a control device including: an acquiring section configured to acquire an output value of a force detecting section at the time when a robot including the force detecting section is operated on the basis of a predetermined setting value; a robot control section configured to cause the robot to perform, for a respective plurality of the setting values, a predetermined first motion on the basis of the setting values; a receiving section configured to receive operation from a user; and a display control section configured to cause a display section to display a time response waveform of the output value acquired by the acquiring section, the time response waveform corresponding to the operation received by the receiving section among the time response waveforms for the respective setting values.

With this configuration, the control device acquires, with the acquiring section, the output value of the force detecting section at the time when the robot including the force detecting section is operated on the basis of the predetermined setting value, causes the robot to perform, for the respective plurality of setting values, the predetermined first motion on the basis of the setting values, receives the operation from the user, and causes the display section to display the time response waveform of the output value acquired by the acquiring section, the time response waveform corresponding to the operation received from the user among the time response waveforms for the respective setting values. Consequently, the control device can operate the robot on the basis of a setting value corresponding to a time response waveform desired by the user.

In another aspect of the invention, in the control device, the display control section may cause, on the basis of the operation received by the receiving section, the display section to display a part or all of the time response waveforms for the respective setting values.

With this configuration, the control device causes, on the basis of the operation received by the receiving section, the display section to display a part or all of the time response waveforms for the respective setting values. Consequently, the control device can cause the user to select a setting value corresponding to a time response waveform desired by the user out of a part or all of the time response waveforms for the respective setting values.

In another aspect of the invention, in the control device, the display control section may cause, on the basis of the operation received by the receiving section, the display section to display a part or all of time response waveforms stored in a storing section in advance.

With this configuration, the control device causes, on the basis of the operation received by the receiving section, the display section to display apart or all of the time response waveforms stored in the storing section in advance. Consequently, the control device can cause the user to select a setting value corresponding to a time response waveform desired by the user out of a part or all of the time response waveforms stored in the storing section.

In another aspect of the invention, in the control device, the robot control section may specify a respective plurality of the setting values on the basis of the operation received by the receiving section and perform, for the respective specified setting values, compliant motion control based on the setting values and the output value of the force detecting section.

With this configuration, the control device specifies the respective plurality of setting values on the basis of the control received by the receiving section and performs, for the respective specified setting values, the compliant motion control based on the setting values and the output value of the force detecting section. Consequently, the control device can operate the robot on the basis of a setting value corresponding to a time response waveform desired by the user among the time response waveforms of the output value of the force detecting section which are results of the compliant motion control performed for the respective specified setting values.

In another aspect of the invention, in the control device, the compliant motion control may be impedance control, and at least a part of imaginary inertia parameters, imaginary elasticity parameters, and imaginary viscosity parameters may be included in the setting values.

With this configuration, the control device specifies, on the basis of operation received from the user, the respective plurality of setting values in which at least a part of the imaginary inertia parameters, the imaginary elasticity parameters, and the imaginary viscosity parameters are included and performs, for the respective specified setting values, the impedance control based on the setting values and the output value of the force detecting section. Consequently, the control device can operate a robot on the basis of a setting value corresponding to a time response waveform desired by the user among the time response waveforms of the output value of the force detecting section in the impedance control performed for the respective specified setting values.

In another aspect of the invention, in the control device, the number of the setting values may be determined in advance or input by the user.

With this configuration, the control device causes the robot to perform, for the respective setting values, the number of which is determined in advance or input by the user, a predetermined first motion on the basis of the setting values. Consequently, the control device can cause the user to select a setting value corresponding to a time response waveform desired by the user out of the time response waveforms for the respective setting values, the number of which is determined in advance or input by the user.

In another aspect of the invention, in the control device, the control device may include a setting section configured to set, in the robot control section, the setting value associated with the time response waveform corresponding to the operation received by the receiving section, and the robot control section may cause the robot to perform a predetermined second motion on the basis of the setting value set by the setting section.

With this configuration, the control device sets the setting value corresponding to the time response waveform corresponding to the received operation and causes the robot to perform the predetermined second motion on the basis of the set setting value. Consequently, the control device can cause the robot to perform work including the second motion, which is a motion desired by the user.

Another aspect of the invention is directed to a robot system including: the control device described above; and a robot controlled by the control device.

With this configuration, the robot system acquires, with an acquiring section, an output value of a force detecting section at the time when a robot including the force detecting section is operated on the basis of a predetermined setting value, cause the robot to perform, for a respective plurality of setting values, a predetermined first motion on the basis of the setting values, receives operation from a user, and causes a display section to display a time response waveform of the output value acquired by the acquiring section, the time response waveform being a time response waveform corresponding to the operation received from the user among the time response waveforms for the respective setting times. Consequently, the robot system can operate the robot on the basis of a setting value corresponding to a time response waveform desired by the user.

As explained above, the control device and the robot system acquire, with the acquiring section, the output value of the force detecting section at the time when the robot including the force detecting section is operated on the basis of the predetermined setting value, cause the robot to perform, for the respective plurality of setting values, the predetermined first motion on the basis of the setting values, receives operation from a user, and causes the display section to display the time response waveform of the output value acquired by the acquiring section, the time response waveform being the time response waveform corresponding to the operation received from the user among the time response waveforms for the respective setting times. Consequently, the control device and the robot system can operate the robot on the basis of a setting value corresponding to a time response waveform desired by the user.

### BRIEF DESCRIPTION OF THE DRAWINGS

The invention will be described with reference to the accompanying drawings, wherein like numbers reference like elements.

FIG. 1 is a diagram showing an example of the configuration of a robot system according to a first embodiment.

FIG. 2 is a diagram showing an example of a hardware configuration of a robot control device and an information processing device.

FIG. 3 is a diagram showing an example of functional configurations of the robot control device and the information processing device.

FIG. 4 is a flowchart for explaining an example of a flow of processing in which the robot control device outputs second information to the information processing device.

FIG. 5 is a diagram illustrating a part of an operation program executed by the robot control device.

FIG. 6 is a flowchart for explaining an example of a flow of processing performed by the information processing device.

FIG. 7 is a diagram showing an example of a main screen.

FIG. 8 is a diagram showing an example of a file selection screen displayed on the main screen.

FIG. 9 is a diagram showing an example of a physical quantity selection screen displayed on the main screen.

FIG. 10 is a diagram showing an example of the main screen including a graph display region in which two graphs are simultaneously displayed.

FIG. 11 is a diagram showing another example of a graph displayed in the graph display region.

FIG. 12 is a flowchart for explaining an example of flow of processing in which the information processing device stores the second information in both of a temporary table and a history information table.

FIG. 13 is a diagram showing an example of the configuration of a robot system according to a second embodiment.

FIG. 14 is a diagram showing an example of respective hardware configurations and functional configurations of a robot, a robot control device, and a teaching device.

FIG. 15 is a flowchart for explaining an example of a flow of teaching processing.

FIG. 16 is a diagram showing an example of a main screen.

### DESCRIPTION OF EXEMPLARY EMBODIMENTS

### First Embodiment

A first embodiment of the invention is explained below with reference to the drawings.

### Configuration of a Robot System

First, the configuration of a robot system 1 is explained.

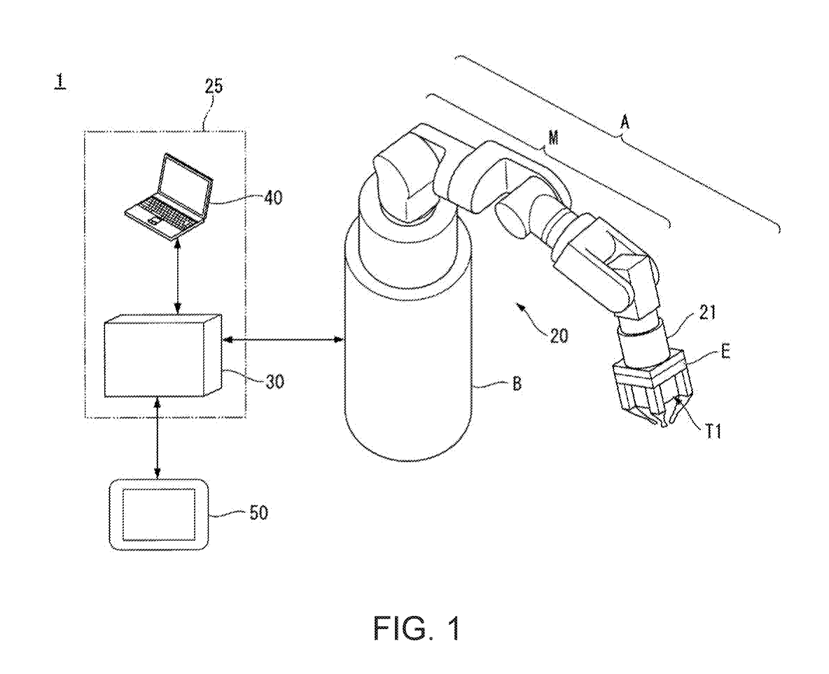

FIG. 1 is a diagram showing an example of the configuration of a robot system according to this embodiment. The robot system 1 includes a robot 20, a control device 25, and a teaching device 50. The control device 25 is configured by a robot control device 30 and an information processing device 40 separate from the robot control device 30. Note that, instead of this configuration, the control device 25 may be configured by integrating the robot control device 30 and the information processing device 40. In this case, the control device 25 has functions of the robot control device 30 and the information processing device 40 explained below.

The robot 20 is a single-arm robot including an arm A and a supporting stand B that supports the arm A. The single-arm robot is a robot including one arm like the arm A in this example. Note that the robot 20 may be a plural-arm robot instead of the single-arm robot. The plural-arm robot is a robot including two or more arms (e.g., two or more arms A). Note that, among plural-arm robots, a robot including two arms is referred to as double-arm robot as well. That is, the robot 20 may be a double-arm robot including two arms or may be a plural-arm robot including three or more arms (e.g., three or more arms A). The robot 20 may be another robot such as a SCARA robot or a Cartesian coordinate robot. The Cartesian coordinate robot is, for example, a gantry robot.

The arm A includes an end effector E, a manipulator M, and a force detecting section 21.

In this example, the end effector E is an end effector including finger sections capable of gripping an object. Note that the end effector E may be an end effector capable of lifting an object with the suction of the air, a magnetic force, a jig, or the like or another end effector instead of the end effector including the finger sections.

The end effector E is communicatively connected to the robot control device 30 by a cable. Consequently, the end effector E performs a motion based on a control signal acquired from the robot control device 30. Note that wired communication via the cable is performed according to a standard such as the Ethernet (registered trademark) or the USB (Universal Serial Bus). The end effector E may be connected to the robot control device 30 by wireless communication performed according to a communication standard such as the Wi-Fi (registered trademark).

The manipulator M includes seven joints. The seven joints respectively include not-shown actuators. That is, the arm A including the manipulator M is an arm of a seven-axis vertical multi-joint type. The arm A performs a motion of a seven-axis degree of freedom according to associated operation by the supporting stand B, the end effector E, the manipulator M, and the actuators of the respective seven joints included in the manipulator M. Note that the arm A may move at a degree of freedom of six or less axes or may move at a degree of freedom of eight or more axes.

When the arm A moves at the seven-axis degree of freedom, postures that the arm A can take increase compared with when the arm A moves at the degree of freedom of six or less axes. Consequently, the arm A can move smoothly and easily avoid interference with an object present around the arm A. When the arm A moves at the seven-axis degree of freedom, computational complexity of the control of the arm A is small and the control of the arm A is easy compared with when the arm A moves at the degree of freedom of eight or more exes.

The seven actuators (included in the joints) included in the manipulator M are respectively communicatively connected to the robot control device 30 by cables. Consequently, the actuators operate the manipulator M on the basis of a control signal acquired from the robot control device 30. The actuators include encoders. The encoders output information indicating rotation angles of the actuators including the encoders to the robot control device 30. Note that wired communication via the cables is performed according to a standard such as the Ethernet (registered trademark) or the USB. Apart or all of the seven actuators included in the manipulator M may be connected to the robot control device 30 by wireless communication performed according to a communication standard such as the Wi-Fi (registered trademark).

The force detecting section 21 is provided between the end effector E and the manipulator M. The force detecting section 21 is, for example, a force sensor. The force detecting section 21 detects a force acting on the end effector E or an object gripped by the end effector E. In this example, the force detected by the force detecting section 21 is explained as a concept including both of a translational force, which is a force for translating the end effector E, and a moment for rotating the end effector E. The force detecting section 21 outputs force detection information including, as an output value, a value indicating the magnitude of the detected force (i.e., the translational force and the moment) to the robot control device 30 through communication.

The force detection information is used for force control, which is control based on force detection information of the arm A by the robot control device 30. The force control means, for example, compliant motion control such as impedance control. Note that the force detecting section 21 may be another sensor that detects the value indicating the magnitude of the force (i.e., the translational force and the moment) applied to the end effector E or the object gripped by the end effector such as a torque sensor.

The force detecting section 21 is communicatively connected to the robot control device 30 by a cable. Wired communication via the cable is performed according to a standard such as the Ethernet (registered trademark) or the USB. Note that the force detecting section 21 and the robot control device 30 may be connected by wireless communication performed according to a communication standard such as the Wi-Fi (registered trademark).

In this example, the robot control device 30 is a robot controller. The robot control device 30 sets a control point T1, which is a TCP (Tool Center Point) moving together with the end effector E, in a position associated with the end effector E in advance. The position associated with the end effector E in advance is, for example, the position of the center of gravity of the end effector E. Note that the position associated with the end effector E may be another position, instead of the position of the center of gravity of the end effector E.

Control point position information, which is information indicating the position of the control point T1, and control point posture information, which is information indicating the posture of the control point T1, are associated with the control point T1. Note that, in addition to these kinds of information, other kinds of information may be associated with the control point T1. When the robot control device 30 designates (determines) the control point position information and the control point posture information, the position and the posture of the control point T1 are determined. The robot control device 30 designates the control point position information and operates the arm A such that the position of the control point T1 coincides with a position indicated by the designated control point position information. The robot control device 30 designates the control point posture information in the position control. The robot control device 30 operates the arm A such that the posture of the control point T1 coincides with a posture indicated by the control point posture information.

In this example, the position of the control point T1 is represented by a position in a robot coordinate system RC of the origin of a control point coordinate system TC1. The posture of the control point T1 is represented by directions in the robot coordinate system RC of coordinate axes of the control point coordinate system TC1. The control point coordinate system TC1 is a three-dimensional local coordinate system associated with the control point T1 to move together with the control point T1. Note that, in this example, the position and the posture of the end effector E are represented by the position and the posture of the control point T1. That is, the translational force for translating the end effector E means a force that can be decomposed into direction components of the coordinate axes of the control point coordinate system TC1. The moment for rotating the end effector E means a moment for rotating the posture of the control point T1 around the coordinate axes.

The robot control device 30 sets the control point T1 on the basis of control point setting information input from a user in advance. The control point setting information is, for example, information indicating relative positions and relative postures of the position and the posture of the center of gravity of the end effector E and the position and the posture of the control point T1. Note that, instead of the information, the control point setting information may be information indicating relative positions and relative postures of some position and posture associated with the end effector E and the position and the posture of the control point T1, may be information indicating relative positions and relative postures of some position and posture associated with the manipulator M and the position and the posture of the control point T1, or may be information indicating relative positions and relative postures of some position and posture associated with another part of the robot 20 and the position and the posture of the control point T1.

The robot control device 30 acquires teaching point information from the teaching device 50. The robot control device 30 stores the acquired teaching point information. The teaching point information is information indicating teaching points. The teaching points are plurality of points through which the robot control device 30 causes the control point T1 to pass when the robot control device 30 operates the arm A. Teaching point position information, teaching point posture information, and teaching point identification information are associated with the teaching points. The teaching point position information is information indicating the positions of the teaching points. The teaching point posture information is information indicating the postures of the teaching points. The teaching point identification information is information for identifying the teaching points.

In this example, the positions of the teaching points are represented by positions in the robot coordinate system RC of the origin of a teaching point coordinate system, which is a three-dimensional local coordinate system associated with the teaching points. The postures of the teaching points are represented by directions in the robot coordinate system RC of coordinate axes of the teaching point coordinate system.

The robot control device 30 operates the robot 20 on the basis of the teaching point information acquired from the teaching device 50 and an operation program input from the user in advance. Specifically, the robot control device 30 executes, in order from a top row, commands described in rows of the operation program. When executing a command for moving the control point T1 among the commands, the robot control device 30 specifies a designated teaching point, which is a teaching point indicated by teaching point identification information designated by the command. The robot control device 30 designates, as control point position information, teaching point position information associated with the specified designated teaching point and designates, as control point posture information, teaching point posture information associated with the designated teaching point. That is, the robot control device 30 performs position control for designating the control point position information and the control point posture information on the basis of the designated teaching point. Consequently, the robot control device 30 can match the control point T1 with the designated teaching point. Note that, in this example, a certain teaching point and the control point T1 coinciding with each other means that the position and the posture of the teaching point and the position and the posture of the control point T1 coincide with each other.

The robot control device 30 acquires force detection information from the force detecting section 21. The robot control device 30 performs force control for correcting, on the basis of the force detection information, the control point position information and the control point posture information designated by the position control explained above. Specifically, in the force control, the robot control device 30 moves the control point T1 in a direction in which the magnitude of a force (i.e., a translational force and a moment) indicated by the force detection information reaches a predetermined value until the magnitude reaches the predetermined value. In this case, the robot control device 30 calculates, on the basis of the force, corrected change amounts, which are amounts for moving the control point T1. The corrected change amounts include a translational corrected movement amount and a rotational corrected angle.

The translational corrected movement amount is an amount for translating the position of the control point T1 from the present position of the control point T1 in a direction of the translational force indicated by the force detection information acquired by the robot control device 30 until the magnitude of the translational force reaches a first predetermined value. In this example, the first predetermined value is 0 [N]. Note that the first predetermined value may be another value instead of 0 [N]. The robot control device 30 calculates the translational corrected movement amount on the basis of force control parameters input to the robot control device 30 in advance, an equation of dynamic motion, and the translational force indicated by the force detection information. The force control parameters mean parameters indicating elasticity, viscosity, and the like in compliant motion control such as impedance parameters.

The rotational corrected angle is an Euler's angle for rotating the posture of the control point T1 from the present posture of the control point T1 in the direction of the moment indicated by the force detection information acquired by the robot control device 30 until the magnitude of the moment reaches a second predetermined value. In this example, the second predetermined value is 0 [N·m]. Note that the second predetermined value may be another value instead of 0 [N·m]. The robot control device 30 calculates the rotational corrected angle on the basis of force control parameters input to the robot control device 30 in advance, the equation of dynamic motion, and the moment indicated by the force detection information.

The robot control device 30 calculates, on the basis of a position indicated by the control point position information designated by the position control and the calculated translational corrected movement amount, as a corrected position, a position translated from the position by the translational corrected movement amount. The robot control device 30 designates, as new control point position information, information indicating the calculated corrected position. The robot control device 30 calculates, on the basis of a posture indicated by the control point posture information designated by the position control and the calculated rotational corrected angle, as a corrected posture, a posture rotated from the posture by the rotational corrected angle. The robot control device 30 designates, as new control point posture information, information indicating the calculated corrected posture. Consequently, the robot control device 30 can match the position and the posture indicated by the control point position information and the control point posture information corrected by the force control and the position and the posture of the control point T1.

In this way, the robot control device 30 can cause, through position control, the robot 20 to perform predetermined work by matching the control point T1 with the teaching points in order of designation of the teaching points by the command for moving the control point T1 among the commands included in the operation program. When the force (the translational force and the moment) is applied to the control point T1 while the robot 20 is performing predetermined work, the robot control device 30 can move the control point T1 to cancel the force.

When moving the control point T1, the robot control device 30 calculates, on the basis of inverse kinetics, rotation angles for realizing the position and the posture indicated by the control point position information and the control point posture information, the rotation angles being rotation angles of the actuators included in the manipulator M. The robot control device 30 generates a control signal indicating the calculated rotation angle. The robot control device 30 transmits the generated control signal to the robot 20 and operates the actuators to thereby move the control point T1. The control signal includes a control signal for controlling the end effector E. Note that the robot control device 30 may be incorporated in the robot 20 instead of being set on the outside of the robot 20.

The robot control device 30 outputs second information associated with first information to another device. The first information is information indicating operation being executed by the robot control device 30, the operation being operation for causing the robot 20 to perform predetermined work. In this example, the other device is the information processing device 40. Consequently, the robot control device 30 can perform, with the information processing device 40, storage and display of the second information associated with the first information indicating the operation being executed by the robot control device 30, the operation being the operation for causing the robot 20 to perform the predetermined work. Note that the other device, which is an output destination to which the robot control device 30 outputs the second information, may be some device different from the information processing device 40 instead of the information processing device 40.

The first information is, for example, information designated by a tag command among the commands stored in the operation program. In the following explanation, as an example, the information is a tag ID. For example, when the tag command is “stepID” and the tag ID designated by the tag command is “1”, the tag command and the tag ID are described as “stepID=1” in the operation program. Note that information designated by the tag command may be other information instead of the tag ID.

The tag command is a command for dividing processing commands for respective desired groups in the operation program. The processing commands mean commands other than the tag command among the commands included in the operation program. One or more processing commands are included in the group. That is, the tag command is information indicating timing when the processing commands included in the groups in the operation program start to be executed. Therefore, when two or more processing commands are included in a certain group in the operation program, a processing command included in another group is absent between any two processing commands among the two or more processing commands. The tag command is information indicating groups including tag commands.

When the robot control device 30 executes the tag command in the operation program, the robot control device 30 detects (specifies) a tag ID designated by the executed tag command. The robot control device 30 specifies, as one group, processing commands included between the executed tag command and the next tag command. The robot control device 30 associates the detected tag ID with the processing commands included in the specified group.

Note that the first information may be, instead of the information (in this example, the tag ID) designated by the tag command, other information indicating the operation being executed by the robot control device 30, the operation being the operation for causing the robot 20 to perform the predetermined work. The tag ID may be a number for identifying the group, may be a character string for identifying the group, may be a sign for identifying the group, or may be a combination of the number, the character string, and the sign or other information.

The second information is, for example, information including control amount information, physical quantity information, command information, and success and failure information. Note that the second information may be information including other kinds of information instead of apart or all of these kinds of information or may be information including other kinds of information in addition to these kinds of information.

The control amount information is information indicating control amounts with which the robot control device 30 controls the robot 20. The control amounts indicated by the control amount information respectively mean an amount designated by the robot control device 30 when operating the robot 20, an amount calculated by the robot control device 30 when operating the robot 20, an amount input to the robot control device 30 in advance, and time clocked by the robot control device 30. In this example, the control amounts are respectively the position and the posture of the designated teaching point, the corrected change amounts, the time, and the force control parameters. The position and the posture of the designated teaching point mean the position and the posture of a teaching point designated by the robot control device 30 through position control immediately before the control amount information is generated, that is, a position and a posture indicated by control point position information and control point posture information designated by the robot control device 30 through position control immediately before the control amount information is generated. The corrected change amounts mean corrected change amounts calculated by the robot control device 30 through force control immediately before the control amount information is generated. The time is time clocked by the robot control device 30 with a not-shown clocking section and is time immediately before the control amount information is generated. Note that the control amount information may be information indicating other control amounts instead of a part or all of these control amounts or may be information indicating other control amounts in addition to these control amounts.

The physical quantity information is information indicating physical quantities representing an operation state of the robot 20. In this example, the physical quantities indicated by the physical quantity information mean a force, speed, acceleration, angular velocity, and angular acceleration. The force is a force (i.e., a translational force and a moment) indicated by force detection information acquired by the robot control device 30 immediately before the physical quantity information is generated. The speed is the speed of the control point T1 immediately before the physical quantity information is generated. The acceleration is the acceleration of the control point T1 immediately before the physical quantity information is generated. The angular velocity is angler velocities of the joints of the manipulator M immediately before the physical quantity information is generated. The angular acceleration is angular accelerations of the joints immediately before the physical quantity information is generated. Note that the physical quantity information may be information indicating other physical quantities instead of apart or all of these physical quantities or may be information indicating other physical quantities in addition to these physical quantities.

The command information is information indicating a processing command executed by the robot control device 30 immediately before the command information is generated. The success and failure information is information indicating success or failure of the predetermined work performed by the robot 20.

As explained above, the second information is information associated with the first information. That is, in this example, the second information is information associated with the first information (i.e., the tag ID) associated with the command indicated by the command information included in the second information.

The robot control device 30 calculates the respective physical quantities indicated by the physical quantity information on the basis of information indicating rotation angles acquired from the encoders included in the joints of the manipulator M. As a calculation method for the physical quantities, a known method may be used or a new method to be developed in future may be used. Therefore, explanation of the calculation method is omitted.

When a predetermined success condition is satisfied at timing when all the commands of the operation program are finished to be executed, the robot control device 30 determines that the predetermined work is successful. The success condition is a condition that a force (i.e., a translational force and a moment) included in the physical quantity information of the second information at the timing is within a predetermined range. On the other hand, when the predetermined success condition is not satisfied at the timing when all the commands of the operation program are finished to be executed, the robot control device 30 determines that the predetermined work has ended in failure. The robot control device 30 generates the success and failure information as a result of such determination. Note that the predetermined condition may be, instead of these conditions, other conditions such as acquisition of information indicating some error from another device and detection of some error by the own device. The errors are, for example, interference between the robot 20 and anther object and an unintended drop of an object gripped by the robot 20.

The robot control device 30 generates the second information every time a predetermined time elapses during the execution of the operation program. The time is, for example, 0.5 second. Note that the time may be another time instead of 0.5 second. The robot control device 30 outputs the generated second information to the information processing device 40. The robot control device 30 outputs the second information to the information processing device 40 in a form such as TCP (Transmission Control Protocol)/IP (Internet Protocol) or UDP (User Datagram Protocol). Note that the robot control device 30 may output, thorough broadcast, the second information to the information processing device 40 connected via a LAN (Local Area Network) or the like. The robot control device 30 may generate the second information in response to a request from the information processing device 40 and output the generated second information to the information processing device 40.

Note that the robot control device 30 generates the second information including null information as the success and failure information from timing when a command included in the operation program is started to be executed to timing when all the commands are finished to be executed, that is, while success or failure indicated by the success and failure information is not determined.

In the following explanation, for convenience of explanation, the control amount information and the physical quantity information are collectively referred to as output amount information. In the following explanation, the control amounts indicated by the control amount information and the physical quantities indicated by the physical quantity information are collectively referred to as output amounts.

The information processing device 40 is, for example, a notebook PC (Personal Computer). Note that the information processing device 40 may be, instead of the notebook PC, another information processing device such as a teaching pendant, a desktop PC, a tablet PC, a multifunction cellular phone terminal (a smartphone), a cellular phone terminal, or a PDA (Personal Digital Assistant).

The information processing device 40 acquires the second information associated with the first information from the robot control device 30 every time a predetermined time elapses while the robot control device 30 is executing the operation program. The information processing device 40 displays the acquired second information and the first information associated with the second information. Consequently, the information processing device 40 can visually provide the user with the second information and the first information associated with the second information.

Specifically, the information processing device 40 displays a graph based on the second information associated with the first information and the first information. The graph based on the second information means graphs respectively representing temporal changes of a part or all of one or more output amounts indicated by the output amount information included in the second information. In this case, the information processing device 40 displays, among the graphs, a graph selected on the basis of operation received from the user. Consequently, the information processing device 40 can visually provide the user with, in a part of the second information associated with the first information, the part desired by the user. In this example, a part of the second information is a part of one or more kinds of information included in the second information.

The information processing device 40 stores history information indicating a history of the second information acquired from the robot control device 30. The display processing device 40 displays a part of the stored history information, the part being selected from the history information on the basis of operation received from the user. In this example, apart of the history information means apart of one or more kinds of history information stored in the information processing device 40. Consequently, the information processing device 40 can visually provide the user with a part of the stored history information, the part being desired by the user.

In this example, the teaching device 50 is a teaching pendant. The teaching device 50 generates teaching point information on the basis of operation from the user. The teaching device 50 outputs the generated teaching point information to the robot control device 30 and causes the robot control device 30 to store the teaching point information.

### Hardware Configuration of the Robot Control Device and the Information Processing Device

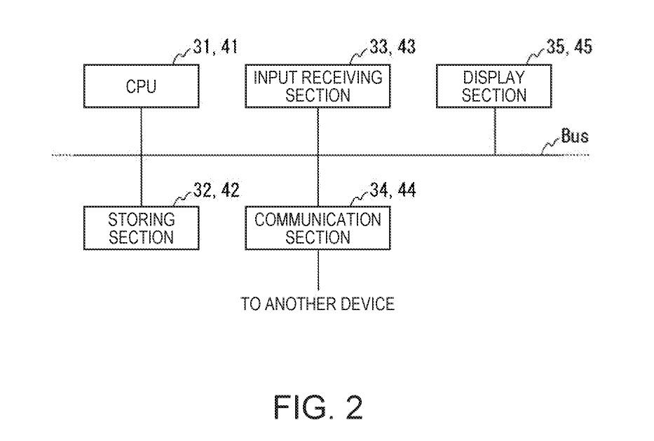

A hardware configuration of the robot control device 30 and the information processing device 40 are explained below with reference to FIG. 2.

FIG. 2 is a diagram showing an example of the hardware configurations of the robot control device 30 and the information processing device 40. FIG. 2 is a diagram showing a hardware configuration of the robot control device 30 (functional sections added with reference numerals in thirties in FIG. 2) and a hardware configuration of the information processing device 40 (functional sections added with reference numerals in forties in FIG. 2) together for convenience.

The robot control device 30 includes, for example, a CPU (Central Processing Unit) 31, a storing section 32, an input receiving section 33, a communication section 34, and a display section 35. The robot control device 30 performs communication with each of the robot 20, the information processing device 40, and the teaching device 50 via the communication section 34. These components are communicatively connected to one another via a bus Bus.

The information processing device 40 includes, for example, a CPU 41, a storing section 42, an input receiving section 43, a communication section 44, and a display section 45. The information processing device 40 performs communication with the robot control device 30 via the communication section 44. These components are communicatively connected to one another via the bus Bus.

The CPU 31 executes various computer programs stored in the storing section 32.

The storing section 32 includes, for example, a HDD (Hard Disk Drive) or an SSD (Solid State Drive), an EEPROM (Electrically Erasable Programmable Read-Only Memory), a ROM (Read-Only Memory), or a RAM (Random Access Memory). Note that the storing section 32 may be, instead of a storing section incorporated in the robot control device 30, an external storage device connected by, for example, a digital input/output port such as the USB. The storing section 32 stores various kinds of information and images to be processed by the robot control device 30, various computer programs including an operation program, and teaching point information.

The input receiving section 33 is, for example, a touch panel configured integrally with the display section 35. Note that the input receiving section 33 may be a keyboard, a mouse, a touch pad, or another input device.

The communication section 34 includes, for example, a digital input/output port such as the USB or the Ethernet (registered trademark) port.

The display section 35 is, for example, a liquid crystal display panel or an organic EL (Electro Luminescence) display panel.

The CPU 41 executes various computer programs stored in the storing section 42.

The storing section 42 includes, for example, a HDD or an SSD, an EEPROM, a ROM, or a RAM. Note that the storing section 42 may be, instead of a storing section incorporated in the information processing device 40, an external storage device connected by, for example, a digital input/output port such as the USB. The storing section 42 stores various kinds of information and images to be processed by the information processing device 40, the various computer programs, and a second information table. The second information table is a table that stores the second information.

The input receiving section 43 is, for example, a touch panel configured integrally with the display section 45. Note that the input receiving section 43 may be a keyboard, a mouse, a touch pad, or another input device.

The communication section 44 includes, for example, a digital input/output port such as the USB or the Ethernet (registered trademark) port.

The display section 45 is, for example, a liquid crystal display panel or an organic EL display panel.

### Functional Configurations of the Robot Control Device and the Information Processing Device

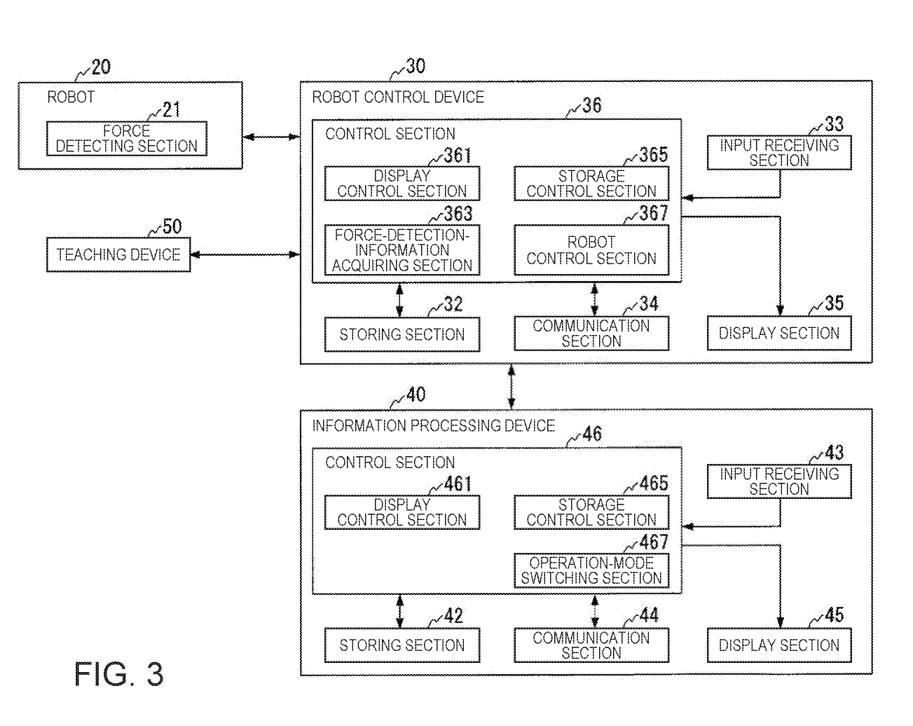

Functional configurations of the robot control device 30 and the information processing device 40 are explained below with reference to FIG. 3.

FIG. 3 is a diagram showing an example of the functional configurations of the robot control device 30 and the information processing device 40.

The robot control device 30 includes the storing section 32, the input receiving section 33, the communication section 34, the display section 35, and a control section 36.

The control section 36 controls the entire robot control device 30. The control section 36 includes a display control section 361, a force-detection-information acquiring section 363, a storage control section 365, and a robot control section 367. These functional sections included in the control section 36 are realized by, for example, the CPU 31 executing various computer programs stored in the storing section 32. A part or all of the functional sections may be hardware functional sections such as an LSI (Large Scale Integration) and an ASIC (Application Specific Integrated Circuit).

The display control section 361 generates various screens that the display control section 361 causes the display section 35 to display. The display control section 361 causes the display section 35 to display the generated screens.

The force-detection-information acquiring section 363 acquires force detection information from the force detecting section 21.

The storage control section 365 causes the storing section 32 to store teaching point information acquired from the teaching device 50. The storage control section 365 causes the storing section 32 to store operation program information indicating an operation program input by the user with a screen on which the user inputs the operation program among the screens displayed on the display section 35.

The robot control section 367 reads out the teaching point information and the operation program information stored in the storing section 32. The robot control section 367 causes the robot 20 to perform the predetermined work through position control and force control based on the read-out teaching point information and operation program information and the force detection information acquired by the force-detection-information acquiring section 363.

The information processing device 40 includes the storing section 42, the input receiving section 43, the communication section 44, the display section 45, and a control section 46.

The control section 46 controls the entire information processing device 40. The control section 46 includes a display control section 461, a storage control section 465, and an operation-mode switching section 467. These functional sections included in the control section 46 are realized by, for example, the CPU 41 executing various computer programs stored in the storing section 42. A part or all of the functional sections may be hardware functional sections such as an LSI and an ASIC.

The display control section 461 generates various screens that the display control section 461 causes the display section 45 to display. The display control section 461 causes the display section 45 to display the generated screens.

The storage control section 465 generates the second information table in a storage region of the storing section 42. The storage control section 465 stores the second information acquired from the robot control device 30 in the second information table.

The operation-mode switching section 467 switches an operation mode of the information processing device 40 on the basis of operation received from the user. Details of the operation mode are explained below.

Processing in which the Robot Control Device Outputs the Second Information to the Information Processing Device

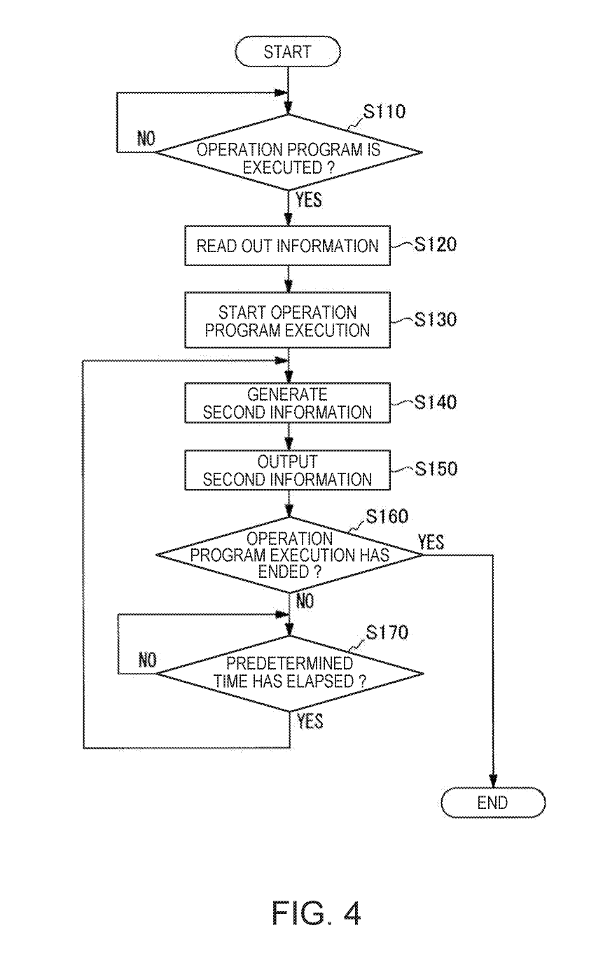

Processing in which the robot control device 30 outputs the second information to the information processing device 40 is explained with reference to FIG. 4.

FIG. 4 is a flowchart for explaining an example of a flow of the processing in which the robot control device 30 outputs the second information to the information processing device 40. Note that, in the flowchart of FIG. 4, the robot control device 30 has already stored teaching point information acquired from the teaching device 50 in the storing section 32.

The robot control section 367 stays on standby until the robot control section 367 receives operation for executing an operation program from the user on a screen that the display control section 361 causes the display section 35 to display or until the robot control section 367 acquires (receives) an instruction for executing the operation program from the information processing device 40 (step S110). When determining that the operation is received from the user or the instruction is acquired from the information processing device 40 (YES in step S110), the robot control section 367 reads out the teaching point information and the operation program information from the storing section 32 (step S120). Subsequently, the robot control section 367 starts, on the basis of the teaching point information read out from the storing section 32, execution of the operation program read out from the storing section 32 (step S130).

Subsequently, the robot control section 367 acquires, from the encoders included in the actuators of the manipulator M, information indicating rotation angles of the actuators. The robot control section 367 calculates, on the basis of the acquired information indicating the rotation angles, speed of the control point T1, acceleration of the control point T1, angular velocities of the joints included in the manipulator M, and angular accelerations of the joints. The robot control section 367 detects the present time from a not-shown clocking section. The robot control section 367 specifies the position and the posture of a designated teaching point that is currently designated. The robot control section 367 calculates corrected change amounts on the basis of the specified position and posture, the force detection information acquired by the force-detection-information acquiring section 363 from the force detecting section 21, and force control parameters input in advance. The robot control section 367 generates the second information, with which the tag ID is associated as the first information, on the basis of the calculated speed, acceleration, angular velocity, angular acceleration, and the corrected change amounts, the detected time, the force control parameters, a command currently being executed, the specified position and posture of the designated teaching point, and a tag ID associated with the command (step S140).

Subsequently, the robot control section 367 outputs the second information generated in step S140 to the information processing device 40 (step S150). Subsequently, the robot control section 367 determines whether the execution of the operation program has ended (step S160). When determining that the execution of the operation program has ended (YES in step S160), the robot control section 367 ends the processing. On the other hand, when determining that the execution of the operation program has not ended (No in step S160), the robot control section 367 stays on standby until a predetermined time elapses (step S170). When determining that the predetermined time has elapsed (YES in step S170), the robot control section 367 shifts to step S140 and generates the second information again.

Consequently, the robot control device 30 can perform, with the information processing device 40, storage and display of the second information with which the first information (i.e., the tag ID) is associated as information capable of specifying, with the tag ID, a correspondence relation between the command executed by the robot control device 30 and the second information. The user can specify, on the basis of the second information stored and displayed by the information processing device 40, a cause of an unintended motion of the robot 20, a factor that should be adjusted in order to cause the robot 20 to perform intended operation, and the like. As a result, the user can improve work efficiency by the robot 20.

### Example of an Operation Program Executed by the Robot Control Device

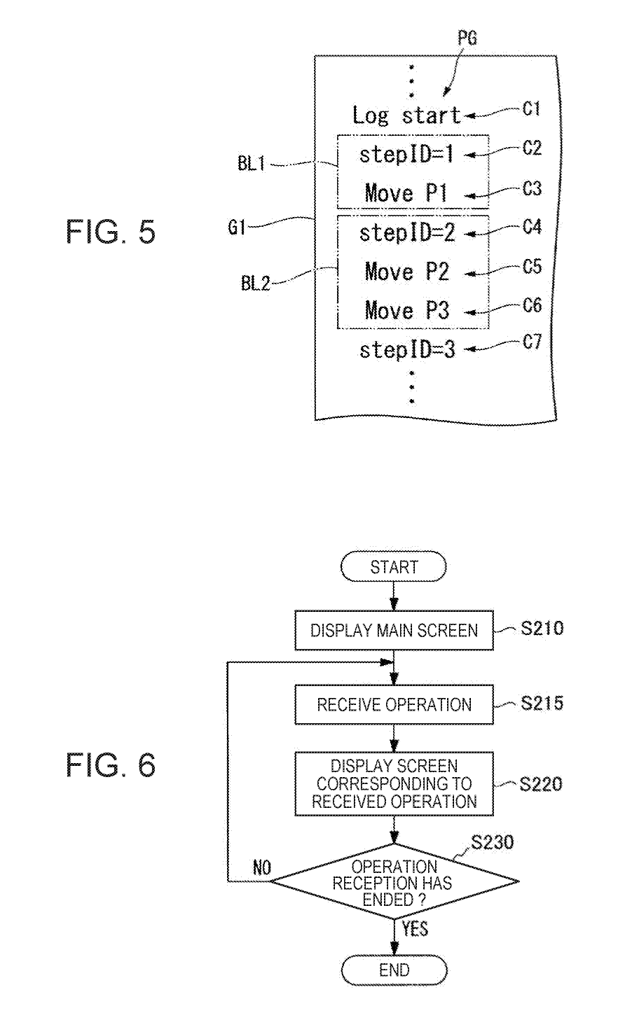

An operation program executed by the robot control device 30 is explained with reference to FIG. 5.

FIG. 5 is a diagram illustrating a part of the operation program executed by the robot control device 30. A screen G1 shown in FIG. 5 is a screen to which the user inputs the operation program among the screens that the display control section 361 causes the display section 35 to display. An operation program PG, which is an example of the operation program, is displayed on the screen G1. Respective seven commands C1 to C7 shown in FIG. 5 are a part of commands included in the operation program PG. The robot control section 367 executes the operation program PG by executing the commands included in the operation program PG row by row in order from the top.

The command C1 is a command for starting execution of the processing from steps S140 to S170 shown in FIG. 4, that is, processing for performing generation and output of the second information.

The command C2 is a tag command for designating 1 as a tag ID.

The command C3 is a processing command for designating P1 as teaching point identification information associated with a designated teaching point and is a processing command for matching the control point T1 with the designated teaching point indicated by P1.

The command C4 is a tag command for designating 2 as a tag ID.

The command C5 is a processing command for designating P2 as teaching point identification information associated with a designated teaching point and is a processing command for matching the control point T1 with the designated teaching point indicated by P2.

The command C6 is a processing command for designating P3 as teaching point identification information associated with a designated teaching point and is a processing command for matching the control point T1 with the designated teaching point indicated by P3.

The command C7 is a tag command for designating 3 as a tag ID.

A group BL1 of commands is a group of processing commands associated with the tag ID designated by the command C2. That is, 1 is associated with the command C3 as the tag ID.

A group BL2 of commands is a group of processing commands associated with the tag ID designated by the command C4. That is, 2 is associated with the command C5 and the command C6 as the tag ID.

The robot control section 367 executes such an operation program on the basis of the teaching point information. The robot control section 367 generates the second information associated with the first information and outputs the generated second information to the information processing device 40. Consequently, the robot control device 30 can perform, with the information processing device 40, storage and display of the second information associated with the first information.

### Processing Performed by the Information Processing Device

Processing performed by the information processing device 40 is explained with reference to FIG. 6.

FIG. 6 is a flowchart for explaining an example of a flow of the processing performed by the information processing device 40. Note that, in the flowchart of FIG. 6, immediately before the processing in step S210 is started, the information processing device 40 has already received, from the user, operation for displaying a main screen, which is a screen for causing the information processing device 40 to perform various kinds of processing.

After receiving the operation for displaying the main screen, the display control section 461 generates the main screen. The display control section 461 causes the display section 45 to display the generated main screen (step S210). Subsequently, the control section 46 receives operation from the user on the main screen that the control section 46 causes the display section 45 to display in step S210 (step S215). Subsequently, the functional sections of the control section 46 perform, on the basis of the operation from the user received in step S215, processing corresponding to the operation (step S220). The processing is explained below. Subsequently, the display control section 461 determines whether the reception of the operation from the user on the main screen has ended (step S230). For example, when receiving operation for deleting the main screen from the user on the main screen, the display control section 461 determines that the reception of the operation from the user on the main screen has ended. When determining that the reception of the operation from the user on the main screen has ended (YES in step S230), the display control section 461 ends the processing. On the other hand, when the display control section 461 determines that the reception of the operation from the user on the main screen has not ended (NO in step S230), the control section 46 shifts to step S215 and receives operation from the user on the main screen again.

Processing of the Information Processing Device Corresponding to Operation from the User Received on the Main Screen

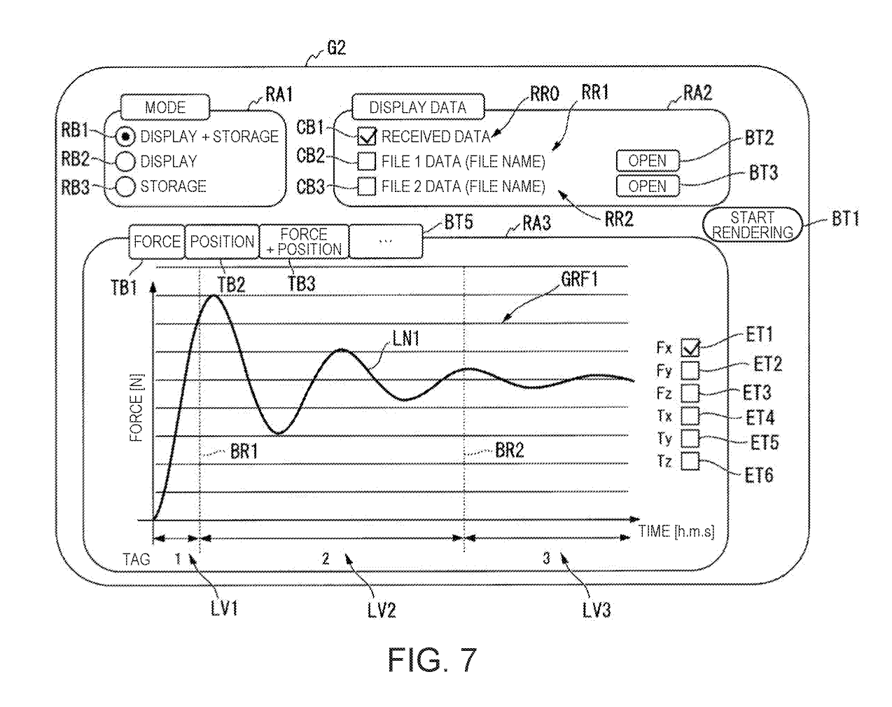

Processing of the information processing device 40 corresponding to operation from the user received on the main screen is explained with reference to FIG. 7. That is, processing of the information processing device 40 in step S215 and step S220 shown in FIG. 6 is explained with reference to FIG. 7.

FIG. 7 is a diagram showing an example of the main screen. A main screen G2 shown in FIG. 7 is an example of the main screen that the display control section 461 causes the display section 45 to display in step S210.

The main screen G2 includes, for example, a mode selection region RA1, a display data selection region RA2, an information display region RA3, and a button BT1. Note that the main screen G2 may include other kinds of information and GUIs (Graphical User Interfaces) in addition to the regions and the button.

The mode section region RA1 is a region where the user selects an operation mode of the information processing device 40.

The display data selection region RA2 is a region where the user selects a desired second information table used to generate a graph displayed on the information display region RA3.

The information display region RA3 is a region for displaying a graph generated on the basis of the second information table selected by the user in the display data selection region RA2, the graph representing a temporal change of an output amount indicated by output amount information included in the second information stored in the second information table.

The button BT1 is a button for executing operations performed by the display control section 461 and the storage control section 465 in the operation mode selected by the user in the mode selection region RA1.

In the mode selection region RA1, the user can select the operation mode of the information processing device 40 out of three operation modes, that is, a first mode, a second mode, and a third mode. The first mode is an operation mode for displaying a graph in the information display region RA3 and storing a history in the storing section 42. The graph means a graph representing a temporal change of a target output amount included in second information stored in a target second information table. The target second information table means a second information table selected by the user in the display data selection region RA2. The target output amount means an output amount selected by the user in the information display region RA3 among one or more output amounts indicated by output amount information. The history means a history of the second information acquired from the robot control device 30. The second mode is an operation mode for displaying a graph in the information display region RA3. The graph means a graph representing a temporal change of the target output amount included in the second information stored in the target second information table. The third mode is an operation mode for storing the history in the storing section 42. The history means the history of the second information acquired from the robot control device 30.

When the operation mode of the information processing device 40 is the first mode, when the button BT1 is tapped by the user, the control section 46 outputs an instruction for causing the robot control device 30 to execute the operation program to the robot control device 30. The storage control section 465 generates a temporary table in a storage region of the storing section 42. In this case, the storage control section 465 generates the temporary table associated with temporary table identification information for identifying the temporary table. The temporary table is the second information table in which the second information acquired from the robot control device 30 is temporarily stored. The storage control section 465 generates a history information table in the storage region of the storing section 42. In this case, the storage control section 465 generates the history information table associated with history information table identification information for identifying the history information table. The history information table is the second information table in which the second information acquired from the robot control device 30 is stored.

The storage control section 465 acquires the second information from the robot control device 30 every time a predetermined time elapses. The storage control section 465 stores the acquired second information in both of the generated temporary table and the generated history information table. In this example, the second information stored in the history information table means history information indicating a history of the second information. When the operation mode of the information processing device 40 is the first mode, when the button BT1 is tapped by the user, the display control section 461 generates a graph representing a temporal change of the target output amount included in the second information stored in the target second information table. The display control section 461 displays the generated graph in the information display region RA3. When there are two or more target second information tables, the display control section 461 generates, for the respective target second information tables, graphs representing temporal changes of the target output amounts included in the second information stored in the target second information tables.

When the operation mode of the information processing device 40 is the second mode, when the button BT1 is tapped by the user, the display control section 461 generates a graph representing a temporal change of the target output amount included in the second information stored in the target second information table. The display control section 461 displays the generated graph in the information display region RA3. When there are two or more target second information tables, the display control section 461 generates, for the respective target second information tables, graphs representing temporal changes of the target output amounts included in the second information stored in the target second information tables.

When the operation mode of the information processing device 40 is the third mode, when the button BT1 is tapped by the user, the control section 46 outputs an instruction for causing the robot control device 30 to execute the operation program to the robot control device 30. The storage control section 465 generates a temporary table in the storage region of the storing section 42. In this case, the storage control section 465 generates the temporary table associated with temporary table identification information for identifying the temporary table. The storage control section 465 generates a history information table in the storage region of the storing section 42. In this case, the storage control section 465 generates the history information table associated with history information table identification information for identifying the history information table. The storage control section 465 acquires the second information from the robot control device 30 every time a predetermined time elapses. The storage control section 465 stores the acquired second information in both of the generated temporary table and the generated history information table.

In the example shown in FIG. 7, the mode selection region RA1 includes information indicating the first mode, a radio button RB1 associated with the information, information indicating the second mode, a radio button RB2 associated with the information, information indicating the third mode, and a radio button RB3 associated with the information. Note that the mode selection region RA1 may include other kinds of information and GUIs in addition to the information and the radio buttons.

In FIG. 7, in the mode selection region RA1, a character string “display+storage” is displayed as information indicating the first mode. In the mode selection region RA1, the radio button RB1 associated with the character string is displayed on the left side of the character string in FIG. 7. In the mode selection region RA1, a character string “display” is displayed as information indicating the second mode. In the mode selection region RA1, the radio button RB2 associated with the character string is displayed on the left side of the character string in FIG. 7. In the mode selection region RA1, a character string “storage” is displayed as information indicating the third mode. In the mode selection region RA1, the radio button RB3 associated with the character string is displayed on the left side of the character string in FIG. 7.

The user can select the operation mode of the information processing device 40 by tapping (clicking) anyone of the three radio buttons (the radio buttons RB1 to RB3) displayed in the mode selection region RA1.

For example, when the user taps the radio button RB1, the display control section 461 displays, on the radio button RB1, information indicating that the radio button RB1 is selected. The operation-mode switching section 467 switches the present operation mode of the information processing device 40 to the first mode. In FIG. 7, the mode selection region RA1 in a state in which the radio button RB1 is selected by the user is shown. In the mode selection region RA1, a black circle is displayed on the radio button RB1 as the information indicating that the radio button RB1 is selected. Note that the information may be other kind of information such as a check mark or a change of a color of a radio button instead of the black circle.

For example, when the user taps the radio button RB2, the display control section 461 displays, on the radio button RB2, information indicating that the radio button RB2 is selected. The operation-mode switching section 467 switches the present operation mode of the information processing device 40 to the second mode.

For example, when the user taps the radio button RB3 associated with a character string “storage”, the display control section 461 displays, on the radio button RB3, information indicating that the radio button RB3 is selected. The operation-mode switching section 467 switches the present operation mode of the information processing device 40 to the third mode.

In the display data selection region RA2, the user can select one or more second information tables desired by the user out of the one or more second information tables stored in the storing section 42 as the temporary table and the history information table.

In the example shown in FIG. 7, in the display data selection region RA2, information RR0 representing received data, a checkbox CB1 associated with the information, a first field RR1, a checkbox CB2 associated with the first field RR1, a button BT2 associated with the first field RR1, a second field RR2, a checkbox CB3 associated with the second field RR2, and a button BT3 associated with the second field RR2 are displayed.

The received data means the second information table stored in the storing section 42 as the temporary table. That is, the information RR0 representing the received data represents the temporary table. The first field RR1 means a field in which a file name selected by the user on a file selection screen displayed when the button BT2 is tapped by the user is displayed. In this example, the file name means history information table identification information for identifying the respective one or more history information tables stored in the storing section 42. That is, the file name represents the history information table identified by the file name. The second field RR2 means a field in which a file name selected by the user on a file selection screen displayed when the button BT3 is tapped by the user is displayed. The file name means history information table identification information for identifying the respective one or more history information tables stored in the storing section 42. That is, the file name represents the history information table identified by the file name.

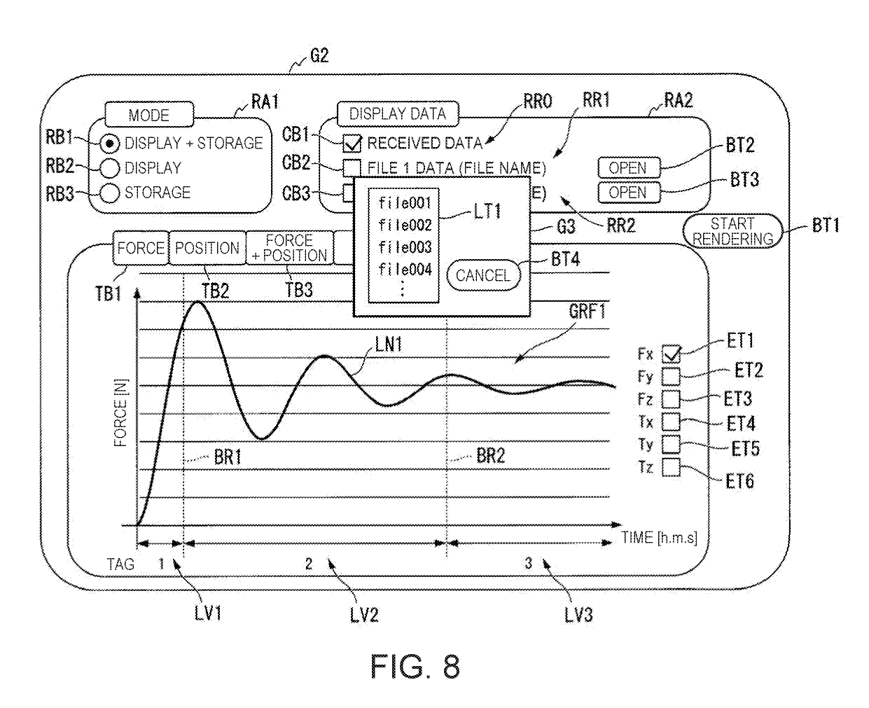

The file selection screen is explained with reference to FIG. 8.

FIG. 8 is a diagram showing an example of the file selection screen displayed on the main screen G2. A file selection screen G3 shown in FIG. 8 is an example of the file selection screen displayed when the button BT2 or the button BT3 is tapped by the user. The file selection screen G3 includes a file list display region LT1 and a button BT4. Note that the file selection screen G3 may include other kinds of information and GUIs in addition to the region and the button.

The file list display region LT1 is a region where file names for identifying the one or more history information tables stored in the storing section 42 are displayed. In the example shown in FIG. 8, in the file list display region LT1, “file0001”, which is a file name representing a first history information table, “file0002”, which is a file name representing the second history information table, “file0003”, which is a file name representing a third history information table, “file0004”, which is a file name representing a fourth history information table, and the like are displayed.

On the file selection screen G3 displayed when the user taps the button BT2, when the user taps one of the one or more file names displayed in the file list display region LT1, the display control section 461 causes the display section 45 to display, in the first field RR1 shown in FIG. 7, the file name tapped by the user. The display control section 461 deletes the file selection screen G3 from the main screen G2. When the button BT4 is tapped on the file selection screen G3, the display control section 461 deletes the file selection screen G3 from the main screen G2. That is, the button BT4 is a button for cancelling the selection of the file name by the user on the file selection screen G3.

On the file selection screen G3 displayed when the user taps the button BT3, when the user taps one of the one or more file names displayed in the file list display region LT1, the display control section 461 causes the display section 45 to display, in the second field RR2 shown in FIG. 7, the file name tapped by the user. The display control section 461 deletes the file selection screen G3 from the main screen G2. When the button BT4 is tapped on the file selection screen G3, the display control section 461 deletes the file selection screen G3 from the main screen G2.

Referring back to FIG. 7, in the display data selection region RA2 shown in FIG. 7, a character string “received data” is displayed as the information RR0 representing the received data. In the display data selection region RA2, the checkbox CB1 associated with the character string is displayed on the left side of the character string in FIG. 7.

In the first field RR1 in the display data selection region RA2 shown in FIG. 7, a character string “file 1 data (file name)” is displayed as the file name selected by the user on the file selection screen G3. In the display data selection region RA2, the checkbox CB2 associated with the character string is displayed on the left side of the character string in FIG. 7. In the display data selection region RA2, the button BT2 associated with the character string is displayed on the right side of the character string in FIG. 7.

In the second field RR2 in the display data selection region RA2 shown in FIG. 7, a character string “file 2 data (file name)” is displayed as the file name selected by the user on the file selection screen G3. In the display data selection region RA2, the checkbox CB3 associated with the character string is displayed on the left side of the character string in FIG. 7. In the display data selection region RA2, the button BT3 associated with the character string is displayed on the right side of the character string in FIG. 7.

By tapping (clicking) one or more desired checkboxes out of the three checkboxes (the checkboxes CB1 to CB3) displayed in the display data selection region RA2, the user can select, as one or more target second information tables, a part or all of the temporary table represented by the information RR0 representing the received data, the history information table represented by the file name displayed in the first field RR1, and the history information table represented by the file name displayed in the second field RR2.

For example, when the user taps the checkbox CB1, the display control section 461 specifies, as one of the one or more target second information tables, a temporary table represented by the information RR0 representing the received data. When the user taps the checkbox CB2, the display control section 461 specifies, as one of the one or more target second information tables, a history information table represented by the file name displayed in the first field RR1. When the user taps the checkbox CB3, the display control section 461 specifies, as one of the one or more target second information tables, a history information table represented by the file name displayed in the second field RR2.

For example, when the user taps the checkbox CB1 and the checkbox CB2, the display control section 461 specifies, as one of the one or more target second information tables, each of a temporary table represented by the information RR0 representing the received data and a history information table represented by the file name displayed in the first field RR1. When the user taps the checkbox CB2 and the checkbox CB3, the display control section 461 specifies, as one of the one or more target second information tables, each of a history information table represented by the file name displayed in the first field RR1 and a history information table represented by the file name displayed in the second field RR2. When the user taps the checkbox CB1 and the checkbox CB3, the display control section 461 specifies, as one of the one or more target second information tables, each of a temporary table represented by the information RR0 representing the received data and a history information table represented by the file name displayed in the second field RR2.

For example, when the user taps the respective checkboxes CB1 to CB3, the display control section 461 specifies, as one of the one or more target second information tables, each of a temporary table represented by the information RR0 representing the received data, a history information table represented by the file name displayed in the first field RR1, and a history information table represented by the file name displayed in the second field RR2.

When any one of the checkboxes CB1 to CB3 is tapped, the display control section 461 displays, on the checkbox, information indicating that the tapped checkbox is selected. In the example shown in FIG. 7, the information is a check mark displayed on the checkbox. That is, the example shown in FIG. 7 is an example in which the checkbox CB1 is selected by the user. Note that the information may be, instead of the check mark, another kind of information such as a black circle or a change of a color of the check mark.

In the following explanation, as an example, as shown in FIG. 7, only the checkbox CB1 is tapped by the user. Note that, as explained above, when two or more checkboxes are tapped by the user out of the checkboxes CB1 to CB3, the display control section 461 generates, for the respective two or more target second information tables, graphs representing temporal changes of the target output amounts included in the second information stored in the target second information tables.

In the information display region RA3, the user can display a graph representing a temporal change of the target output amount included in the target second information table. In this example, the target second information table is the temporary table represented by the information RR0 representing the received data. Therefore, the display control section 461 displays a graph representing a temporal change of the target output amount included in the second information included in the temporary table.

In the example shown in FIG. 7, the information display region RA3 includes a button BT5 and a graph display region GRF1. Note that the information display region RA3 may include other kinds of information and GUIs in addition to the button and the region.

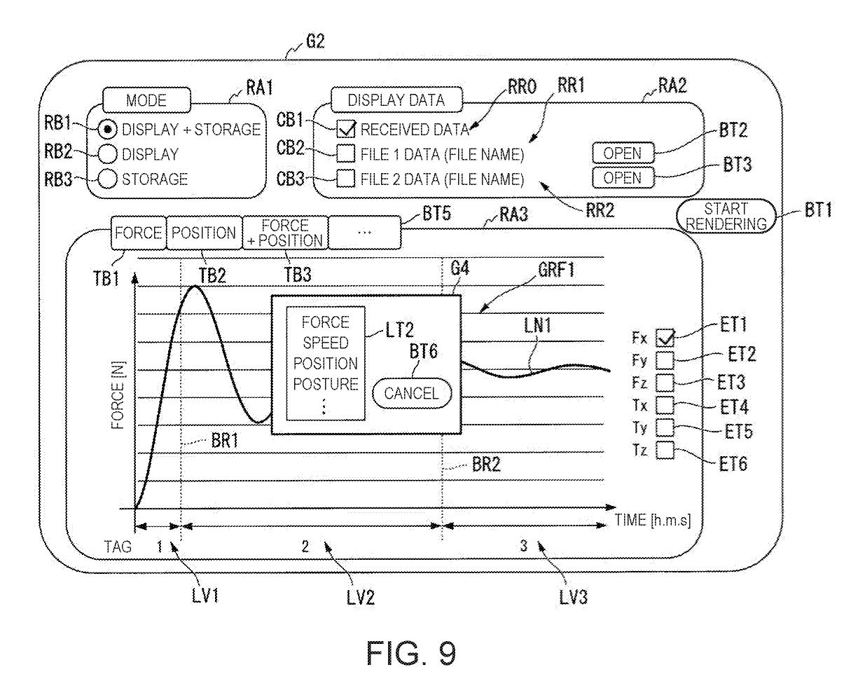

The button BT5 is a button for displaying an output amount selection screen. When the button BT5 is tapped by the user, the display control section 461 displays the output amount selection screen on the main screen G2. The output amount selection screen is a screen on which the user selects a desired output amount as a target output amount. The output amount selection screen is explained with reference to FIG. 9.

FIG. 9 is a diagram showing an example of the output amount selection screen displayed on the main screen G2.

An output amount selection screen G4 shown in FIG. 9 is an example of an output amount selection screen displayed when the button BT5 is tapped by the user. The output amount selection screen G4 includes an output amount list display region LT2 and a button BT6. Note that the output amount selection screen G4 may include other kinds of information and GUIs in addition to the region and the button.

The output amount list display region LT2 is a region in which a list of information representing output amounts indicated by output amount information. In the following explanation, as an example, the information representing the output amounts is names of the output amounts. Note that the information may be, instead of the names of the output amounts, other kinds of information such as figures representing the output amounts. In the example shown in FIG. 9, in the output amount list display region LT2, “force”, which is a name of a force among the output amounts indicated by the output amount information, “speed”, which is a name of speed among the output amounts, “position”, which is a name of a position of a designated teaching point among the output amounts, “posture”, which is a name of a posture of the designated teaching point among the output amounts, and the like are displayed.

When the user taps one of one or more names displayed in the output amount list display region LT2, the display control section 461 specifies, as one of target output amounts, an output amount represented by a name tapped by the user. When a plurality of names are tapped by the user within a predetermined period, the display control section 461 specifies, as one of the target output amounts, a combination of the tapped plurality of names. The predetermined period is, for example, two seconds. Note that the predetermined period may be another time instead of 2 seconds.

The button BT6 is a button for deleting the output amount selection screen G4 from the main screen G2. When the button BT6 is tapped by the user, the display control section 461 deletes the output amount selection screen G4 from the main screen G2.

Referring back to FIG. 7, when one or more target output amounts (including a combination of two or more output amounts) are selected by the user on the output amount selection screen G4, the display control section 461 displays, for the respective selected one or more target output amounts, tabs associated with the target output amounts in the information display region RA3. In the following explanation, as an example, one or more target output amounts selected by the user on the output amount selection screen G4 are three output amounts, that is, a force, a position, and the force and the position (an example of the combination of two or more output amounts) among the output amounts indicated by the output amount information.

In the example shown in FIG. 7, in the information display region RA3, a tab TB1, a tab TB2, and a tab TB3 are displayed. The tab TB1 is a tab associated with the force among the one or more target output amounts in this example. The tab TB2 is a tab associated with the position among the one or more target output amounts in this example. The tab TB3 is a tab associated with the force and the position among the one or more target output amounts in this example.

By tapping any one of the tabs after tapping the button BT1, the user can display, in the graph display region GRF1, a graph representing a temporal change of a target output amount associated with the tapped tab.

For example, after the button BT1 is tapped by the user, when the tab TB1 among the tabs displayed in the information display region RA3 is tapped by the user, the display control section 461 generates a graph representing a temporal change of the force, which is the target output amount associated with the tab TB1 among the target output amounts included in the second information stored in the target second information table. In this example, the display control section 461 generates a graph representing a temporal change of the force, which is the target output amount associated with the tab TB1 among the target output amounts included in the second information stored in the temporary table. The display control section 461 displays the generated graph in the graph display region GRF1.

For example, after the button BT1 is tapped by the user, when the tab TB2 among the tabs displayed in the information display region RA3 is tapped by the user, the display control section 461 generates a graph representing a temporal change of the position (the position of the designated teaching point), which is the target output amount associated with the tab TB2 among the target output amounts included in the second information stored in the target second information table. In this example, the display control section 461 generates a graph representing a temporal change of the position, which is the target output amount associated with the tab TB2 among the target output amounts included in the second information stored in the temporary table. The display control section 461 displays the generated graph in the graph display region GRF1.

For example, after the button BT1 is tapped by the user, when the tab TB3 among the tabs displayed in the information display region RA3 is tapped by the user, the display control section 461 generates graphs respectively representing temporal changes of the force and the position (the position of the designated teaching point), which are the target output amounts associated with the tab TB3 among the target output amounts included in the second information stored in the target second information table. In this example, the display control section 461 generates graphs representing temporal changes of the force and the position, which are the target output amounts associated with the tab TB3 among the target output amounts included in the second information stored in the temporary table. The display control section 461 displays the generated two graphs one on top of the other (or side by side) in the graph display region GRF1.

In the example shown in FIG. 7, the tab tapped by the user among the tabs displayed in the information display region RA3 is the tab TB1. Therefore, in the graph display region GRF1, a graph representing a temporal change of the force, which is the target output amount associated with the tab TB1 among the target output amounts included in the second information stored in the temporary table, which is the target second information table in this example, is displayed. A curve LN1 shown in FIG. 7 represents the temporal change of the force. The vertical axis of the graph indicates the force, which is the target output amount. The horizontal axis of the graph indicates time.

In this way, the information processing device 40 can display the graphs representing the temporal changes of the target output amounts included in the second information stored in the target section information table. Consequently, for example, when the target output amounts are control amounts, the user can visually check, every time the user changes force control parameters set in advance in the robot control device 30, temporal changes of the control amounts with which the robot control device 30 controls the robot 20 according to the changed force control parameters. As a result, the user can select, on the basis of the graphs (i.e., the second information), force control parameters suitable for causing the robot 20 to efficiently perform the predetermined work. That is, the information processing device 40 can cause, on the basis of the graphs (i.e., the second information), the user to select force parameters suitable for causing the robot 20 to efficiently perform the predetermined work.

In a graph displayed in the graph display region GRF1, the first information associated with the respective one or more kinds of second information stored in the target second information table used in generating the graph is displayed. When displaying the graph in the graph display region GRF1, the display control section 461 specifies, on the basis of the target second information table used in generating the graph, as one section, a period in which the first information associated with the respective kinds of second information stored in the target second information stored in the target second information table does not change and causes the display section 45 to display, on the graph, information indicating specified one or more sections.

In the example shown in FIG. 7, on the graph displayed in the graph display region GRF1, respective kinds of information LV1 to LV3 are displayed as the information indicating the one or more sections specified by the display control section 461.

In the graph displayed in the graph display region GRF1, the information LV1 is information indicating a section in which 1 is associated with the second information as the tag ID, which is the first information in this example. The information LV1 represents the section with an arrow. The information LV1 represents, with the tag ID (i.e., 1), which is the first information, arranged under the arrow, the first information associated with the second information in the section.

In the graph displayed in the graph display region GRF1, the information LV2 is information indicating a section in which 2 is associated with the second information as the tag ID, which is the first information in this example. The information LV2 represents the section with an arrow. The information LV2 represents, with the tag ID (i.e., 2), which is the first information, arranged under the arrow, the first information associated with the second information in the section.

In the example shown in FIG. 7, the horizontal axis of the graph displayed in the graph display region GRF1 indicates the time (h, m, s). However, when the horizontal axis indicates another amount different from the time, colors and shapes of arrows representing the sections of the respective kinds of information LV1 to LV3 indicating the sections, the tag IDs of which are associated with the second information, may be different from one another. In this case, the sections may be represented by other signs, figures, characters, or the like instead of being represented by the arrows.

In the graph displayed in the graph display region GRF1, the information LV3 is information indicating a section in which 3 is associated with the second information as the tag ID, which is the first information in this example. The information LV3 represents the section with an arrow. The information LV3 represents, with the tag ID (i.e., 3), which is the first information, arranged under the arrow, the first information associated with the second information in the section.

In the graph displayed in the graph display region GRF1, a dotted line BR1 and a dotted line BR2 shown in FIG. 7 are information indicating timings when the first information associated with the second information changed. When displaying a graph in the graph display region GRF1, the display control section 461 displays the information indicating the timings on the graph.

In this way, the information processing device 40 causes, on the basis of the second information table, in which the second information stored, acquired from the robot control device 30, the display section 45 to display, in the graph display region GRF1, the second information and the first information associated with the second information. Consequently, the user can easily specify a command executed by the robot control device 30 in a section in which the robot 20 performs an unintended motion. The user can easily specify a processing command executed by the robot control device 30 in a section in which force control parameters should be adjusted in order to cause the robot 20 to efficiently perform the predetermined work. As a result, the user can select, on the basis of the first information and the second information, force control parameters suitable for causing the robot 20 to efficiently perform work. That is, the information processing device 40 can cause the user to select, on the basis of the first information and the second information, the force control parameters suitable for causing the robot 20 to efficiently perform work.

On the graph displayed in the graph display region GRF1, information indicating one or more degrees of freedom of the target output amounts used in generating the graph and checkboxes associated with the information are displayed. When displaying a graph in the graph display region GRF1, the display control section 461 displays, in the graph display region GRF1, information indicating one or more degrees of freedom of the target output amounts used in generating the graph and checkboxes associated with the information. When generating a graph displayed in the graph display region GRF1, the display control section 461 generates, on the basis of the second information stored in the target second information table used in generating the graph, for respective degrees of freedom of the target output amounts, graphs indicating temporal changes of the degrees of freedom. When the user taps one of kinds of information indicating the degrees of freedom displayed in the graph display region GRF1, the display control section 461 displays, in the graph display region GRF1, the graph indicating the temporal change of the degree of freedom indicated by the tapped information.

In the example shown in FIG. 7, on the graph displayed in the graph display region GRF1, information indicating degrees of freedom of the forces, which are the target output amounts, that is, “Fx”, “Fy”, and “Fz”, which are information indicating three degrees of freedom of a translational force, and “Tx”, “Ty”, and “Tz”, which are information indicating three degrees of freedom of a moment, are displayed. “Fx” is information indicating a degree of freedom in the X-axis direction in the control point coordinate system TC1 among the three degrees of freedom of the translational force. “Fy” is information indicating a degree of freedom in the Y-axis direction in the control point coordinate system TC1 among the three degrees of freedom of the translational force. “Fz” is information indicating a degree of freedom in the Z-axis direction in the control point coordinate system TC1 among the three degrees of freedom of the translational force. “Tx” is information indicating a degree of freedom of rotation around the X axis in the control point coordinate system. TC1 among the three degrees of freedom of the moment. “Ty” is information indicating a degree of freedom of rotation around the Y axis in the control point coordinate system TC1 among the three degrees of freedom of the moment. “Tz” is information indicating a degree of freedom of rotation around the Z axis in the control point coordinate system TC1 among the three degrees of freedom of the moment. On the graph displayed in the graph display region GRF1, checkboxes E11 to ET6 are displayed as checkboxes associated with the respective degrees of freedom.

The checkbox ET1 is a checkbox associated with the degree of freedom indicated by “Fx”. The checkbox ET2 is a checkbox associated with the degree of freedom indicated by “Fy”. The checkbox ET3 is a checkbox associated with a degree of freedom indicated by “Fz”. The checkbox ET4 is a checkbox associated with the degree of freedom indicated by “Tx”. The checkbox ET5 is a checkbox associated with the degree of freedom indicated by “Ty”. The checkbox ET6 is a checkbox associated with the degree of freedom indicated by “Tz”.

In the example shown in FIG. 7, a state is shown in which the checkbox ET1 among the checkboxes is tapped by the user. When the checkbox ET1 is tapped by the user, the display control section 461 displays, in the graph display region GRF1, a graph representing a temporal change of the degree of freedom indicated by “Fx”, which is the information associated with the checkbox ET1, the degree of freedom being the degree of freedom of the target output amount.

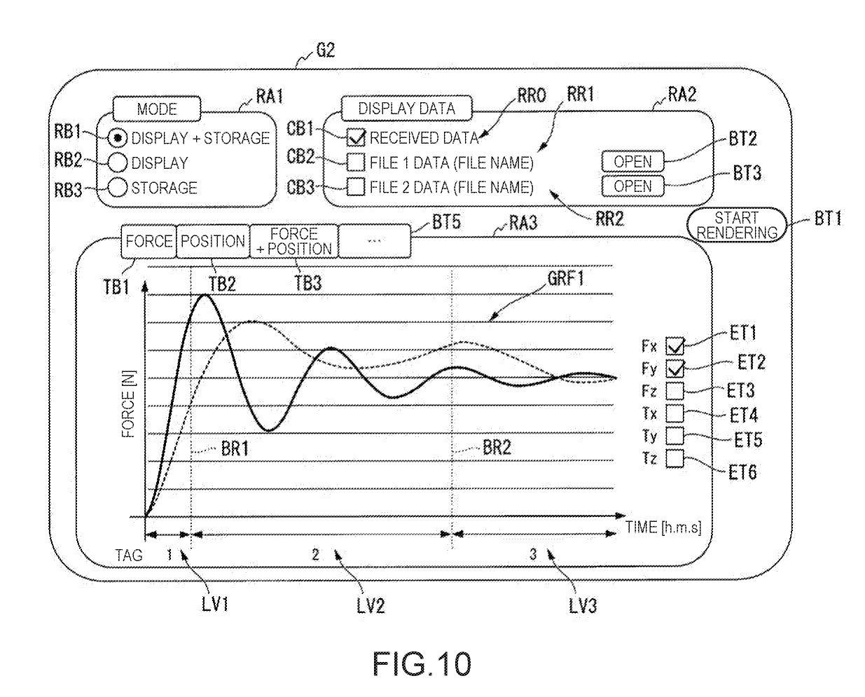

When two or more checkboxes among the checkboxes ET1 to ET6 are tapped by the user, the display control section 461 displays, in the graph display region GRF1, graphs representing temporal changes of the degrees of freedom indicated by the information associated with the respective tapped checkboxes, the degrees of freedom being the degrees of freedom of the target output amounts. For example, when the checkbox ET1 and the checkbox ET2 are tapped by the user, the display control section 461 displays two graphs in the graph display region GRF1. The two graphs are a graph representing a temporal change of a degree of freedom indicated by “Fx”, which is the information associated with the checkbox ET1, the degree of freedom being the degree of freedom of the target output amount, and a graph representing a temporal change of the degree of freedom indicated by “Fy”, which is the information associated with the checkbox ET2, the degree of freedom being the degree of freedom of the target output amount. A display example of the graph display region GRF1 in this case is shown in FIG. 10.

FIG. 10 is a diagram showing an example of the main screen G2 including the graph display region GRF1 in which the two graphs are simultaneously displayed.

In this way, when the checkboxes displayed in the graph display region GRF1 are tapped by the user, the information processing device 40 can display graphs representing temporal changes of one or more degrees of freedom desired by the user among the degrees of freedom of the target output amounts. Consequently, the information processing device 40 can visually provide the user with temporal changes of output amounts for the respective degrees of freedom. As a result, the information processing device 40 can cause the user to easily select force control parameters suitable for causing the robot 20 to efficiently perform the predetermined work.

### Another Example of the Graph Displayed in the Graph Display Region

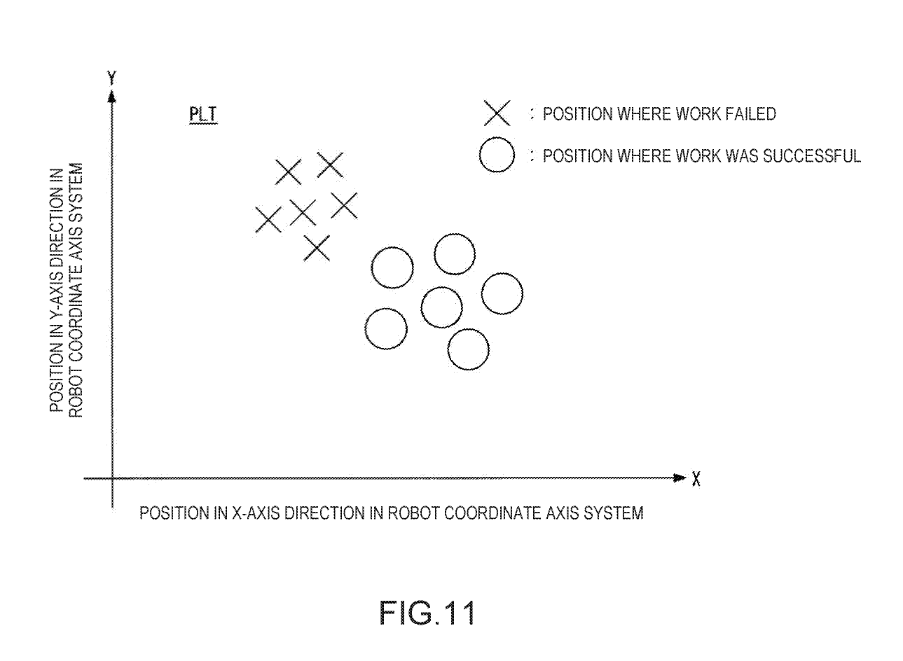

A wavy graph is displayed in the graph display region GRF1 shown in FIGS. 7 to 10. However, the display control section 461 may display a graph of another type instead of the wavy graph. Another example of the graph displayed in the graph display region GRF1 is explained below with reference to FIG. 11.

FIG. 11 is a diagram showing another example of the graph displayed in the graph display region GRF1.

A graph PLT shown in FIG. 11 is shown as a two-dimensional graph in order to simplify the figure. Note that the display control section 461 may display a N-dimensional graph in the graph display region GRF1. N is an integer equal to or larger than 1. The vertical axis of the graph PLT indicates a position in the Y-axis direction in the robot coordinate system RC. The horizontal axis of the graph PLT indicates a position in the X-axis direction in the robot coordinate system RC. The graph PLT is a scatter diagram in which, when the robot control device 30 causes the robot 20 to perform the predetermined work a plurality of times, for the respective plurality of times of the predetermined work, information indicating success or failure of the predetermined work determined at timing when all the commands of the operation program are finished to be executed is plotted with respect to a position of the control point T1 at the timing. The position is a position in the robot coordinate system RC of the control point T1.

The display control section 461 reads out, on the basis of operation received from the user, from the storing section 42, all of a plurality of history information tables stored in a period desired by the user. The display control section 461 generates the graph PLT on the basis of the second information stored in the respective read-out plurality of history information tables. Specifically, the display control section 461 calculates, on the basis of positions and corrected change amounts indicated by the output amount information included in the second information stored in the respective read-out plurality of history information tables, a position of the control point T1 at the timing when all the commands of the operation program are finished to be executed. The display control section 461 generates the graph PLT on the basis of the calculated position and success or failure indicated by the success and failure information included in the second information used to calculate the position.

In the graph PLT shown in FIG. 11, X coordinates and Y coordinates in positions where crosses are plotted indicate positions in the robot coordinate system RC that the control point T1 finally reaches when the robot 20 fails in the predetermined work. On the other hand, in the graph PLT, X coordinates and Y coordinates in positions where circles are plotted indicate positions in the robot coordinate system RC that the control point T1 finally reaches when the robot 20 succeeds in the predetermined work. In the example shown in FIG. 11, it is seen from the graph PLT, the crosses and the circles tend to gather in regions different from each other in the robot coordinate system RC. Therefore, the user can improve possibility of the robot 20 succeeding in the predetermined work by adjusting force control parameters set in the robot control device 30 such that a position in the robot coordinate system RC that the control point T1 finally reaches is a position within the region where the circles gather. That is, the user can adjust, by viewing the graph PLT, force control parameters using, as an index of success or failure of the predetermined work, the position in the robot coordinate system RC that the control point T1 finally reaches in the predetermined work of the robot 20.

In this way, the information processing device 40 can display the scatter diagram in the graph display region GRF1 instead of the wavy graph. In this case, the information processing device 40 generates the scatter diagram on the basis of the plurality of history information tables stored in the storing section 42. Consequently, the information processing device 40 can provide, using the scatter diagram generated on the basis of the plurality of history information tables, the user with information that cannot be represented by the wavy graph. Note that the information processing device 40 may display a graph of another type in the graph display region GRF1 instead of the wavy graph and the scatter diagram.

The information processing device 40 may calculate, on the basis of the number of times the robot 20 performs the predetermined processing and the history information tables generated for the respective times of the predetermined processing stored in the storing section 42, statistical amounts such as an average, dispersion, a peak value, and the like of output amounts desired by the user. In this case, the information processing device 40 may store the calculated statistical amounts in another table different from the second information table. In this case, the information processing device 40 displays graphs corresponding to the calculated statistical amounts in the graph display region GRF1.

Note that the information processing device 40 may or may not change, in the graph display region GRF1 explained above, according to a graph displayed on the basis of operation received by the user, a color, brightness, size, a shape, and the like of plotted dots or signs. For example, the information processing device 40 may display six crosses and six circles shown in FIG. 11 in the graph display region GRF1 respectively in colors different from each other. The information processing device 40 may or may not change, in the graph display region GRF1 explained above, according to a graph displayed on the basis of operation received by the user, a color, brightness, size, a shape, and the like of drawn curves and straight lines. For example, the information processing device 40 may display two curves displayed in the graph display region GRF1 in FIG. 10 in the graph display region GRF1 respectively in colors different from each other.

Processing in which the Information Processing Device Stores the Second Information in the History Information Table

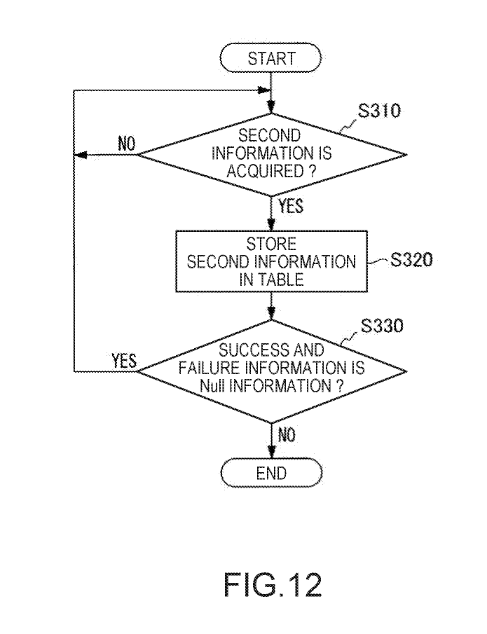

Processing in which the information processing device 40 stores the second information in both of the temporary table and the history information table is explained with reference to FIG. 12.

FIG. 12 is a flowchart for explaining an example of a flow of the processing in which the information processing device 40 stores the second information in both of the temporary table and the history information table. Note that, in FIG. 12, the storage control section 465 has already generated the temporary table and the history information table in the storage region of the storing section 42.

The storage control section 465 stays on standby until the second information is acquired from the robot control device 30 (step S310). When determining that the second information is acquired from the robot control device 30 (YES in step S310), the storage control section 465 stores the acquired second information in both of the temporary table and the history information table stored in the storing section 42 (step S320). Subsequently, the storage control section 465 determines whether the success and failure information included in the second information acquired in step S310 is Null information (step S330). When determining that the success and failure information included in the second information is the Null information (YES in step S330), the storage control section 465 shifts to step S310 and stays on standby until the second information is acquired from the robot control device 30 again. On the other hand, when determining that the success and failure information included in the second information acquired in step S310 is not the Null information (NO in step S330), the storage control section 465 ends the processing.

In this way, the information processing device 40 stores the second information acquired from the robot control device 30 in both of the temporary table and the history information table stored in the storing section 42. Consequently, the information processing device 40 can visually provide the user with a part of the one or more kinds of second information stored in the history information table stored in the storing section 42, the part being desired by the user.

Note that the second information explained above may include, for example, image pickup section related information, which is information concerning an image pickup section, and visual servo related information, which is information concerning control of the robot 20 by visual servo. The image pickup section related information includes, for example, information indicating a position in a robot coordinate system in which the image pickup section is set and information indicating the number of pixels of the image pickup section. The visual servo related information includes, for example, information indicating a reference model used for the visual servo.

### Data Structure of the Second Information Table

A data structure of the second information table is explained below. Any data structure may be adopted as the data structure of the second information table explained above.

For example, the data structure of the second information table may be configured by an actual data section, a header section, and a footer section as explained below.

The actual data section stores various kinds of information stored in the second information table explained above.

The header section stores start times of the storage of the respective kinds of information in the actual data section, names and units of the kinds of information, any character strings designated by the user in order to indicate the kinds of information, storage intervals of the kinds of information, storage scheduled times of the kinds of information, start conditions of the storage of the kinds of information, end conditions of the storage of the kinds of information, information indicating a device such as a sensor that outputs the kinds of information, and the like.

The footer section stores, for example, end reasons of the storage of the kinds of information. The end reasons include, for example, elapse of a scheduled time, achievement of the end conditions, and occurrence of an unintended motion.

Note that the actual data section, the header section, and the footer section may include other information according to necessity.

As explained above, the robot control device 30 outputs the second information associated with the first information (in this example, the tag ID) indicating operation being executed by the robot control device 30, the operation being operation for causing the robot 20 to perform work, to the other device (in this example, the information processing device 40). Consequently, the robot control device 30 can perform, with the other device, storage and display of the second information associated with the first information indicating the operation being executed by the robot control device 30, the operation being the operation for causing the robot 20 to perform work.

The robot control device 30 outputs the second information associated with the first information, the second information including the information indicating the control amounts for controlling the robot 20, to the other device. Consequently, the robot control device 30 can perform, with the other device, storage and display of the second information associated with the first information, the second information including the information indicating the control amounts for controlling the robot 20.

The robot control device 30 outputs the second information associated with the first information, the second information including the information indicating the physical quantities representing the operation state of the robot 20, to the other device. Consequently, the robot control device 30 can perform, with the other device, storage and display of the second information associated with the first information, the second information including the information indicating the physical quantities representing the operation state of the robot 20.

The information processing device 40 acquires the second information associated with the first information from the robot control device 30 and causes the display section to display the acquired second information and the first information associated with the second information. Consequently, the information processing device 40 can visually provide the user with the second information and the first information associated with the second information.

The information processing device 40 causes the display section (in this example, the display section 45) to display a part of the second information, the part being selected from the second information on the basis of operation received from the user. Consequently, the information processing device 40 can visually provide the user with a part desired by the user in the part of the second information.

The information processing device 40 stores, in the storing section (in this example, the storing section 42), history information indicating a history of the second information acquired from the robot control device 30 and causes the display section to display a part of the history information, the part being selected from the history information on the basis of operation received from the user. Consequently, the information processing device 40 can visually provide the user with a part of the stored history information, the part being desired by the user.

The information processing device 40 selects, on the basis of operation received from the user, out of a plurality of kinds of the first information, the first information associated with the second information including the information indicating the corrected change amounts, which are amounts for changing, through force control, the position and the posture of the control point of the robot and displays, on the display section, at least a part of the second information associated with the selected first information. Consequently, the information processing device 40 can visually provide the user with at least a part of the second information including the information indicating the corrected change amounts, which are the amounts for changing the position and the posture of the control point of the robot through the force control, the part being desired by the user.

### Second Embodiment

A second embodiment of the invention is explained below with reference to the drawings. Constituent members same as the constituent members in the first embodiment are denoted by the same reference numerals and signs and explanation of the constituent members is omitted or simplified.

### Configuration of a Robot System

First, the configuration of a robot system 2 is explained.

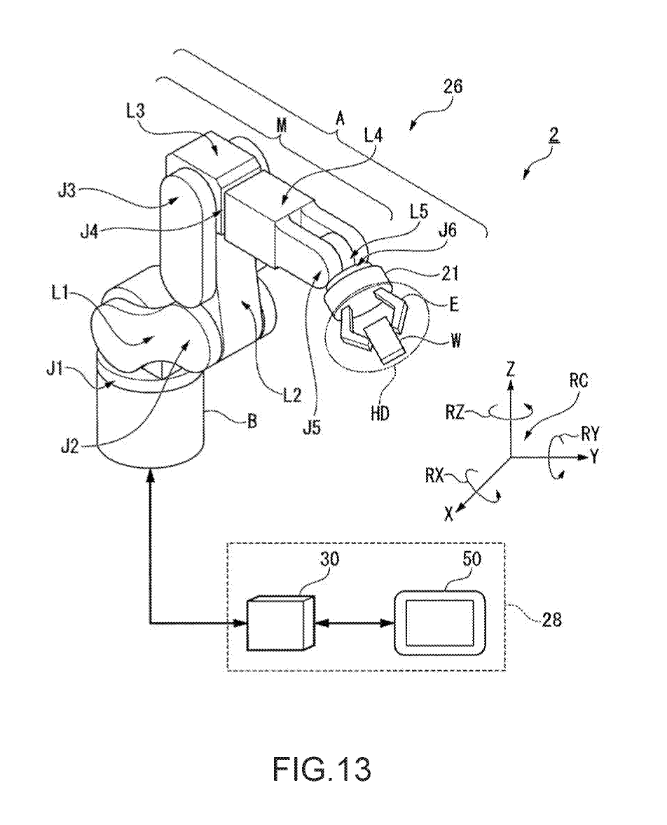

FIG. 13 is a diagram showing an example of the configuration of a robot system according to this embodiment. The robot system 2 includes a robot 26 and a control device 28. The control device 28 is configured by the robot control device 30 and the teaching device 50 separate from the robot control device 30. Note that, instead of this configuration, the control device 28 may be configured by integrating the robot control device 30 and the teaching device 50. In this case, the control device 28 has functions of the robot control device 30 and the teaching device 50 explained below.

The robot 26 is a single-arm robot including the arm A and the supporting stand B that supports the arm A. Note that the robot 26 may be a plural-arm robot instead of the single-arm robot. The robot 26 may be a double-arm robot including two arms or may be a plural-arm robot including three or more arms (e.g., three or more arms A). The robot 26 may be another robot such as a SCARA robot or a Cartesian coordinate robot. The Cartesian coordinate robot is, for example, a gantry robot.

The manipulator M includes links L1 to L5, which are five arm members, and joints J1 to J6, which are six joints. The supporting stand B and the link L1 are coupled by the joint J1. The link L1 and the link L2 are coupled by the joint J2. The link L2 and the link L3 are coupled by the joint J3. The link L3 and the link L4 are coupled by the joint J4. The link L4 and the link L5 are coupled by the joint J5. The link L5 and the end effector E are coupled by the joint J6. That is, the arm A including the manipulator M is an arm of a six-axis vertical multi-joint type. Note that the arm may move at a degree of freedom of five or less axes or may move at a degree of freedom of seven or more axes.

The joints J2, J3, and J5 are respectively bending joints. The joints J1, J4, and J6 are respectively twisting joints. As explained above, the end effector E for performing gripping, machining, and the like on work (e.g., work W shown in FIG. 13) is coupled (attached) to the joint J6. In the following explanation, a predetermined position on a rotation axis of the joint J6 at the distal end is represented as TCP. The position of the TCP serves as a reference of the position of the end effector E. The joint J6 includes the force detecting section 21.

The force detecting section 21 is, for example, a six-axis force sensor. The force detecting section 21 detects the magnitudes of forces on three detection axes orthogonal to one another and the magnitudes of torques around the three detection axes. The forces mean forces acting on a hand HD. The hand HD means the end effector E or an object griped by the end effector E. The torques mean torques acting on the hand HD. Note that the force detecting section 21 may be, instead of the force sensor, another sensor capable of detecting a force and torque acting on the hand HD such as a torque sensor.

In FIG. 13, the end effector E that grips the work W is attached to the distal end of the joint J6. In the following explanation, a coordinate system defining a space in which the robot 26 is set is represented as the robot coordinate system RC. The robot coordinate system RC is a three-dimensional orthogonal coordinate system defined by an X axis and a Y axis orthogonal to each other on a horizontal plane and a Z axis having a positive direction in the vertical upward direction. In the following explanation, for convenience of explanation, it is assumed that, when the X axis is simply referred to, the X axis represents the X axis in the robot coordinate system RC, when the Y axis is simply referred to, the Y axis represents the Y axis in the robot coordinate system RC, and, when the Z axis is simply referred to, the Z axis represents the Z axis in the robot coordinate system RC. A rotation angle around the X axis in the robot coordinate system RC is represented by a rotation angle RX. A rotation angle around the Y axis in the robot coordinate system RC is represented by a rotation angle RY. A rotation angle around the Z axis in the robot coordinate system RC is represented by a rotation angle RZ. Therefore, any position in the robot coordinate system RC can be represented by a position DX in the X-axis direction, a position DY in the Y-axis direction, and a position DZ in the Z-axis direction. Any posture in the robot coordinate system RC can be represented by a rotation angle RX, a rotation angle RY, and a rotation angle RZ. In the following explanation, for convenience of explanation, when a position is referred to, the position can also mean a posture. When a force is referred to, the force can also mean torques acting in rotating directions of the respective rotation angles RX, RY, and RZ. The robot control device 30 controls the position of the TCP in the robot coordinate system RC by driving the arm A.

The end effector E, the manipulator M, and the force detecting section 21 are communicatively connected to the robot control device 30 respectively by cables. Note that wired communication via the cables is performed according to a standard such as the Ethernet (registered trademark) or the USB. A part or all of the seven actuators included in the manipulator M may be connected to the robot control device 30 by wireless communication performed according to a communication standard such as the Wi-Fi (registered trademark).

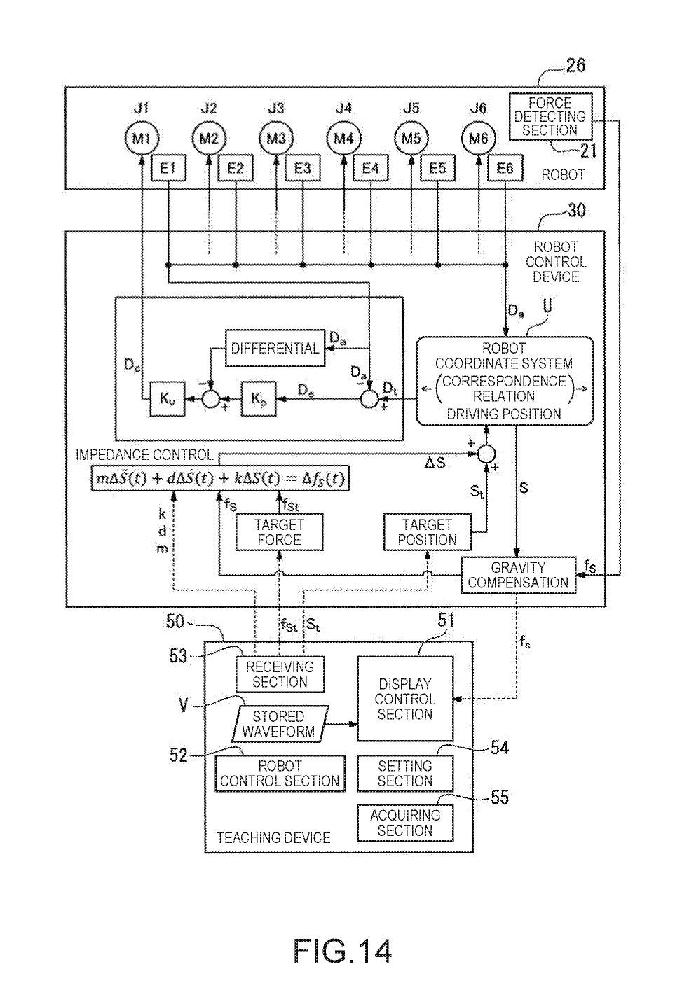

FIG. 14 is a diagram showing an example of respective hardware configurations and functional configurations of the robot 26, the robot control device 30, and the teaching device 50. A control program for performing control of the robot 26 is installed in the robot control device 30. The robot control device 30 includes a processor, a RAM, and a ROM. These hardware resources cooperate with the control program. Consequently, the robot control device 30 functions as a control section.

The robot control device 30 controls the arm A such that, for example, a target position and a target force set by teaching work by the user are realized in the TCP. The target force is a force that the force detecting section 21 should detect. S shown in FIG. 13 represents any one direction among directions of axes defining the robot coordinate system RC (the X-axis direction, the Y-axis direction, the Z-axis direction, the direction of the rotation angle RX, the direction of the rotation angle RY, and the direction of the rotation angle RZ). For example, when the direction represented by S is the X-axis direction, an X-axis direction component of the target position set in the robot coordinate system RC is represented as Sₜ=Xₜ and an X-axis direction component of the target force is represented as f_{St}=f_{Xt}. S also represents a position in the direction represented by S.

The robot 26 includes motors M1 to M6 functioning as driving sections and encoders E1 to E6 besides the components shown in FIG. 13. The motor M1 and the encoder E1 are included in the joint J1. The encoder E1 detects a driving position of the motor M1. The motor M2 and the encoder E2 are included in the joint J2. The encoder E2 detects a driving position of the motor M2. The motor M3 and the encoder E3 are included in the joint J3. The encoder E3 detects a driving position of the motor M3. The motor M4 and the encoder E4 are included in the joint J4. The encoder E4 detects a driving position of the motor M4. The motor M5 and the encoder E5 are included in the joint J5. The encoder E5 detects a driving position of the motor M5. The motor M6 and the encoder E6 are included in the joint J6. The encoder E6 detects a driving position of the motor M6. Controlling the arm A means controlling the motors M1 to M6.

The robot control device 30 stores a correspondence relation U between a combination of the driving positions of the motors M1 to M6 and the position of the TCP in the robot coordinate system RC. The robot control device 30 stores target positions Sₜ and target forces f_{St} for respective processes of work performed by the robot 26. The target positions Sₜ and target forces f_{St} are set by teaching work explained below.

When the robot control device 30 acquires driving positions Dₐ of the motors M1 to M6, the robot control device 30 converts, on the basis of the correspondence relation U, the driving positions Da into the positions S of the TCP (the position DX, the position DY, the position DZ, the rotation angle RX, the rotation angle RY, and the rotation angle RZ) in the robot coordinate system RC. The robot control device 30 specifies, on the basis of the position S of the TCP and an output value of the force detecting section 21, in the robot coordinate system RC, a force f_{S} acting on the force detecting section 21. The output value is a value indicating the force f_{S} detected by the force detecting section 21. Note that the force detecting section 21 detects the force f_{S} in an original coordinate system. However, since relative positions and relative directions of the force detecting section 21 and the TCP are stored as known data, the robot control device 30 can specify the force f_{S} in the robot coordinate system RC. The robot control device 30 performs gravity compensation on the force f_{S}. The gravity compensation is removal of a gravity component from the force f_{S}. The force f_{S} subjected to the gravity compensation can be regarded as a force other than the gravity acting on the hand HD.

The robot control device 30 specifies a force-deriving correction amount ΔS by substituting the target force f_{St} and the force f_{S} in an equation of motion of compliant motion control. In the following explanation, as an example, the compliant motion control is impedance control. That is, the robot control device 30 specifies the force-deriving correction amount ΔS by substituting the target force f_{St} and the force f_{S} in an equation of motion of the impedance control. Expression (1) described below is the equation of motion of the impedance control.

mΔ\ddot{S}(t)+dΔ\dot{S}(t)+kΔS(t)=Δf_{S}(t) (1)

The left side of Expression (1) described above is formed by a first term obtained by multiplying a second order differential value of the position S of the TCP with an imaginary inertia parameter m, a second term obtained by multiplying a first order differential value of the position S of the TCP with an imaginary viscosity parameter d, and a third term obtained by multiplying the position S of the TCP with an imaginary elasticity parameter k. The right side of Expression (1) described above is formed by a force deviation Δf_{S}(t) obtained by subtracting the force f_{S} from the target force f_{St}. An argument t of the force deviation Δf_{S}(t) represents time. The differential in Expression (1) described above means differential by the time. The target force f_{St} may be set as a constant value in a process performed by the robot 26 or may be set as a value derived by a function dependent on the time.

The impedance control is control for realizing imaginary mechanical impedance with the motors M1 to M6. The imaginary inertia parameter m means mass that the TCP imaginarily has. The imaginary viscosity parameter d means viscosity resistance that the TCP imaginarily receives. The imaginary elasticity parameter k means a spring constant of an elastic force that the TCP imaginarily receives. The parameters m, d, and k may be set to different values in respective directions or may be set to common values irrespective of the directions. The force-deriving correction amount ΔS means displacement (a translational distance or a rotation angle) to the position S to which the TCP should move in order to cancel (nullify) the force deviation Δf_{S}(t), which is a difference between the target force f_{St} and the force f_{S}, when the TCP receives mechanical impedance. The robot control device 30 adds the force-deriving correction amount ΔS to the target position Sₜ to thereby specify a corrected target position (Sₜ+ΔS) that takes into account the impedance control.

The robot control device 30 converts, on the basis of the correspondence relation U, corrected target positions (Sₜ+ΔS) in the respective six directions (the X-axis direction, the Y-axis direction, the Z-axis direction, the direction of the rotation angle RX, the direction of the rotation angle RY, and the direction of the rotation angle RZ) in the robot coordinate system RC into target driving positions Dₜ, which are target driving positions of the respective motors M1 to M6. The robot control device 30 subtracts present motor driving positions Dₐ from the motor target driving positions Dₜ for the respective six motors (the respective motors M1 to M6) to thereby calculate driving position deviations Dₑ (=Dₜ−Dₐ). The robot control device 30 adds up values obtained by multiplying, with a speed control gain K_{V}, driving speed deviations, which are differences between values obtained by multiplying the driving position deviations Dₑ with a position control gain Kₚ, and driving speed, which is a time differential value of the driving positions Dₐ, and calculates control amounts D_{c}. Note that the position control gain Kₚ and the speed control gain K_{V} may include control gains related to not only a proportional component but also a differential component and an integral component. The control amounts D_{c} are specified concerning the respective motors M1 to M6.

With the configuration explained above, the robot control device 30 can control the arm A on the basis of the target position Sₜ and the target force f_{St}.

A teaching program for teaching the robot control device 30 about the target position Sₜ and the target force f_{St} is installed in the teaching device 50. The teaching device 50 includes a processor, a RAM, and a ROM. These hardware resources cooperate with the teaching program. Consequently, as shown in FIG. 14, the teaching device 50 includes a display control section 51, a robot control section 52, a receiving section 53, a setting section 54, and an acquiring section 55 as functional components. The teaching device 50 includes a not-shown input device and a not-shown output device. The input device is, for example, a mouse, a keyboard, or a touch panel. The input device receives an instruction from the user. The output device is, for example, a display or a speaker. The output device outputs various kinds of information to the user. The output device is an example of the display section. In the following explanation, details of processing performed by the display control section 51, the robot control section 52, the receiving section 53, the setting section 54, and the acquiring section 55 are explained together with flowcharts.

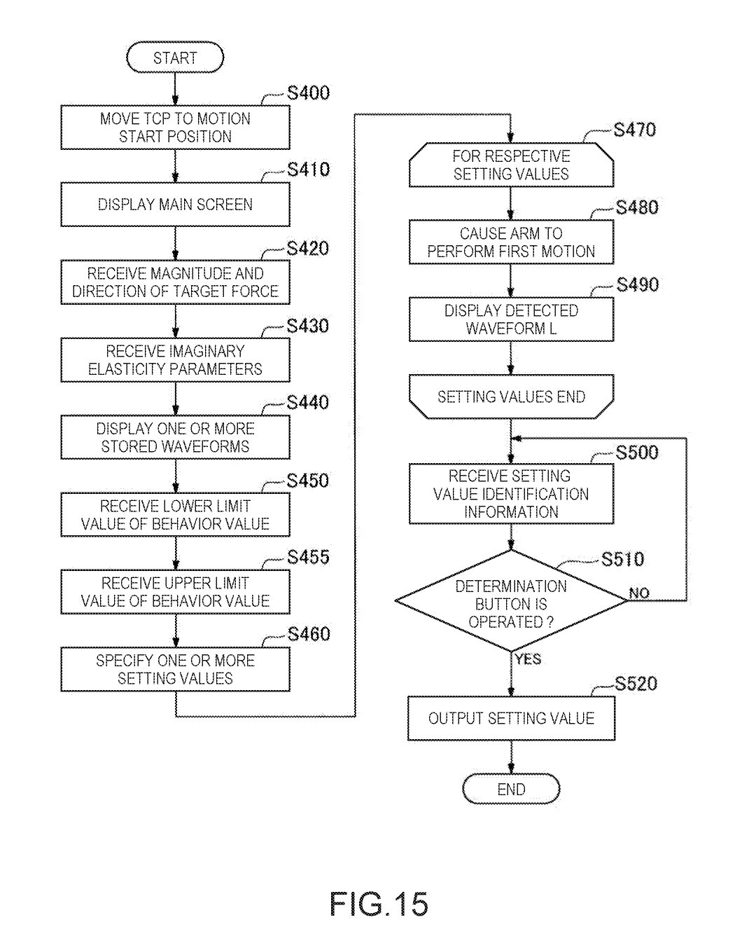

FIG. 15 is a flowchart for explaining an example of a flow of teaching processing. In the flowchart of FIG. 15, processing performed after processing for teaching the target position Sₜ is already performed is explained. That is, the processing of the flowchart is processing for teaching parameters of the impedance control (imaginary elasticity parameters k, imaginary viscosity parameters d, and imaginary inertia parameters m) together with the target force f_{St}. Note that the target position Sₜ can be taught by a publicly-known teaching method. For example, the target position Sₜ may be taught according to movement of the arm A by a hand of the user or may be taught according to designation of a coordinate in the robot coordinate system RC by the teaching device 50.

The robot control section 52 moves the arm A to a motion start position (step S400). That is, the robot control section 52 causes the robot control device 30 to execute control of the arm A for setting the TCP as the motion start position. The motion start position means, for example, the position of the TCP immediately before the arm A is controlled such that a force acts on the force detecting section 21 or a position immediately before another object is machined by the end effector E that grips a machining tool. However, in the processing of the flowchart of FIG. 15, the target force f_{St} and parameters of the impedance control only have to be set. The operation start position does not always have to be the position immediately before the arm A is controlled such that a force acts on the force detecting section 21 in actual work.

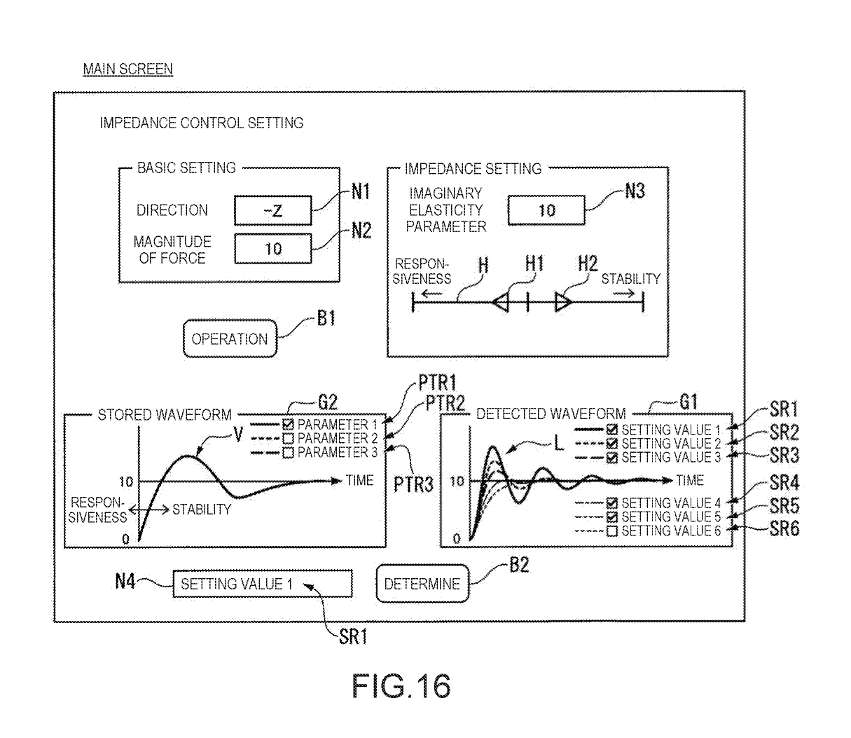

Subsequently, the display control section 51 displays a main screen, which is a GUI, on the not-shown output device (step S410). The main screen is explained with reference to FIG. 16. FIG. 16 is a diagram showing an example of the main screen. The main screen shown in FIG. 16 includes input windows N1 to N4, a slider bar H, graphs G1 and G2, and buttons B1 and B2. The receiving section 53 receives operation performed on the main screen by the not-shown input device.

After the display control section 51 displays the main screen on the not-shown output device in step S410, the receiving section 53 receives the direction of the target force f_{St} and the magnitude of the target force f_{St} (step S420). The main screen includes the input window N1 for receiving the direction of the target force f_{St} and the input window N2 for receiving the magnitude of the target force f_{St}. The receiving section 53 receives, in the input window N1, an input of any one of the six directions in the robot coordinate system RC. The receiving section 53 receives an input of any numerical value in the input window N2.

Subsequently, the receiving section 53 receives the imaginary elasticity parameter k (step S430). The main screen includes the input window N3 for receiving the imaginary elasticity parameter k. The receiving section 53 receives an input of any numerical value in the input window N3. The imaginary elasticity parameter k is an example of the setting value. As the user set the imaginary elasticity parameter k smaller, when the hand HD comes into contact with another object, the hand HD less easily deforms the object. That is, as the user sets the imaginary elasticity parameter k smaller, the hand HD more softly comes into contact with the other object. On the other hand, as the user sets the imaginary elasticity parameter k larger, when the hand HD comes into contact with the other object, the hand HD more easily deforms the object. That is, as the user sets the imaginary elasticity parameter k larger, the hand HD more firmly comes into contact with the other object.

After receiving the imaginary elasticity parameter k in the input window N3, the display control section 51 displays, on the graph G2, one or more stored waveforms V corresponding to the received imaginary elasticity parameter k (step S440). The horizontal axis of the graph G2 indicates time and the vertical axis of the graph G2 indicates a force detected by the force detecting section 21. The stored waveforms V are time response waveforms of a force detected by the force detecting section 21. The stored waveforms V are stored for the respective imaginary elasticity parameters k in a not-shown storage medium of the teaching device 50. Combinations of the imaginary viscosity parameters d and the imaginary inertia parameters m and parameter identification information indicating the combinations are associated with the stored waveforms V for the respective imaginary elasticity parameters k. Note that the storage medium is an example of the storing section.

When the arm A is controlled such that the force having the magnitude received in the input window N2 is detected by the force detecting section 21, the stored waveforms V are time response waveforms of a force detected by the force detecting section 21. When the imaginary elasticity parameters k are a plurality of stored waveforms V different from one another, the shapes (the tilts) of the waveforms are greatly different compared with when the other parameters (the imaginary viscosity parameters d or the imaginary inertia parameters m) are different from one another. Therefore, the stored waveforms V are stored in the storage medium of the teaching device 50 for the respective imaginary elasticity parameters k. Note that the stored waveforms V may be stored in the storage medium of the teaching device 50 for the respective viscosity parameters d instead of being stored in the storage medium of the teaching device 50 for the respective imaginary elasticity parameters k, may be stored in the storage medium of the teaching device 50 for the respective imaginary inertia parameters m, or may be stored in the storage medium of the teaching device 50 for respective parts or all of combinations of the imaginary elasticity parameters k, the imaginary viscosity parameters d, and the imaginary inertia parameters m.

When displaying one or more stored waveforms V on the graph G2, the display control section 51 displays, on the graph G2, parameter identification information associated with the respective one or more stored waveforms V corresponding to the imaginary elasticity parameter k received in the input window N3. In the example shown in FIG. 16, as an example, respective kinds of parameter identification information PTR1 to PTR3, which are three kinds of parameter identification information, are displayed on the graph G2. Checkboxes are associated with the respective kinds of parameter identification information PTR1 to PTR3.

By selecting (performing selection operation for, for example, tapping or clicking) one or more checkboxes out of the checkboxes displayed on the graph G2, the user can select kinds of parameter identification information associated with the respective selected one or more checkboxes. The user can display, on the graph G2, the stored waveforms V associated with the respective selected one or more kinds of parameter identification information.

That is, the display control section 51 specifies, on the basis of operation received from the user, one or more checkboxes desired by the user on the graph G2. The display control section 51 specifies kinds of parameter identification information associated with the respective specified one or more checkboxes. The display control section 51 specifies, as one or more stored waveforms V desired by the user, the stored waveforms V associated with the respective specified one or more kinds of parameter identification information. The display control section 51 reads out, from the not-shown storage medium, the one or more stored waveforms V specified by the display control section 51 and displays the read-out one or more stored waveforms V on the graph G2.

In the example shown in FIG. 16, the user selects only the checkbox associated with the parameter identification information PTR1. Therefore, on the graph G2 shown in FIG. 16, only the stored waveform V associated with the parameter identification information PTR1 is displayed.

Note that the stored waveforms V only have to be waveforms serving as standards for the user. The stored waveforms V may be, for example, waveforms recommended by a manufacturer of the robot 26 or may be waveforms with which the robot 26 normally performed work in the past. The stored waveforms V may be stored in the storage medium of the teaching device 50 for respective work contents of fitting work, polishing work, and the like or may be stored in the storage medium of the teaching device 50 for respective mechanical characteristics (a modulus of elasticity, hardness, etc.) of work W and mechanical characteristics of another object that comes into contact with the hand HD.

Subsequently, according to operation of a slider H1 on the slider bar H, when the hand HD comes into contact with the other object, the receiving section 53 receives a lower limit value of a behavior value, which is a value indicating behavior of a motion corresponding to the contact with the other object, the motion being a motion of the hand HD (step S450). The behavior value indicates a combination of the imaginary viscosity parameter d and the imaginary inertia parameter m. The behavior value is a value that changes when at least one of the imaginary viscosity parameter d and the imaginary inertia parameter m changes. Note that a ratio of the imaginary viscosity parameter d and the imaginary inertia parameter m may be kept constant when the behavior value changes or may change when the behavior value changes.

As the behavior value is smaller (i.e., as the position of the slider H1 further moves in the left direction on the slider bar H), the imaginary viscosity parameter d and the imaginary inertia parameter m decrease. When the imaginary viscosity parameter d and the imaginary inertia parameter m decrease, since the position of the TCP easily moves, responsiveness of the force detected by the force detecting section 21 is improved. That is, when the imaginary viscosity parameter d and the imaginary inertia parameter m decrease, responsiveness of a motion of the hand HD corresponding to the contact with the other object is improved. On the other hand, as the behavior value is larger (i.e., as the position of the slider H1 further moves in the right direction on the slider bar H), the imaginary viscosity parameter d and the imaginary inertia parameter m increase. When the imaginary viscosity parameter d and the imaginary inertia parameter m increase, since the position of the TCP less easily moves, the force detected by the force detecting section 21 easily stabilizes. That is, when the imaginary viscosity parameter d and the imaginary inertia parameter m increase, stability of the motion of the hand HD corresponding to the contact with the other object is improved. Note that the imaginary viscosity parameter d and the imaginary inertia parameter m are examples of the setting values.

Subsequently, the receiving section 53 receives an upper limit value of the behavior value according to operation of a slider H2 on the slider bar H (step S455). Note that the order of the processing in step S450 and the processing in step S455 may be opposite. The behavior value may indicate a combination of the imaginary elasticity parameter k, the imaginary viscosity parameter d, and the imaginary inertia parameter m instead of indicating the combination of the imaginary viscosity parameter d and the imaginary inertia parameter m. In this case, the main screen does not include the input window N3.

Subsequently, the receiving section 53 acquires the lower limit value of the behavior value indicated by a slide position of the slider H1 on the slider bar H and the upper limit value of the behavior value indicated by a slide position of the slider H2. The receiving section 53 specifies behavior values satisfying predetermined conditions out of behavior values included in a range of values equal to or larger than the acquired lower limit value and equal to or smaller than the acquired upper limit value. The predetermined condition is that, for example, when the range is equally divided into five, the behavior values are behavior values located in boundaries among sections adjacent to one another among divided sections. The receiving section 53 specifies the lower limit value, the specified behavior values, and the upper limit value respectively as one or more setting values (in this example, six setting values) (step S460). Note that the predetermined condition may be another condition that one or more behavior values included in the range can be selected instead of the condition that the behavior values are the behavior values located in the boundaries among the sections adjacent to one another among the divided sections. The number of divisions of the range, that is, the number of setting values specified in step S460 may be determined in advance or may be input by the user. When the number of divisions of the range is input by the user, the main screen includes an input window for inputting the number of divisions of the range.

Subsequently, the display control section 51 and the robot control section 52 repeatedly perform, according to operation of the operation button B1, the processing in steps S480 to S490 for the respective one or more setting values specified in step S460 (step S470).

The robot control section 52 causes the arm A to perform a predetermined first motion on the basis of the setting values selected (specified) in step S470 (step S480). That is, the robot control section 52 outputs the imaginary viscosity parameter d and the imaginary inertia parameter m, which are the setting values selected in step S470, and the imaginary elasticity parameter k and the target force f_{St} set on the main screen to the robot control device 30 and instructs the robot control device 30 to cause the arm A to perform the first motion on the basis of the imaginary elasticity parameter k, the imaginary viscosity parameter d, the imaginary inertia parameter m, and the target force f_{St} output to the robot control device 30.

In the case of the main screen shown in FIG. 16, the arm A is controlled such that the hand HD moves in a −Z direction in the first motion and comes into contact with another object in the −Z direction and the force f_{S} having the magnitude set on the main screen is detected by the force detecting section 21. Note that the first motion may be another motion instead of this motion.

While the robot control section 52 is causing the robot control device 30 to control the arm A, the acquiring section 55 acquires the force f_{S} after the gravity compensation (i.e., the output value of the force detecting section 21) from the robot control device 30 at every predetermined sampling frequency. The acquiring section 55 causes the storage medium of the teaching device 50 to store the acquired force f_{S}. Note that, when the behavior value indicates the combination of the imaginary elasticity parameter k, the imaginary viscosity parameter d, and the imaginary inertia parameter m, the setting values mean the imaginary elasticity parameter k, the imaginary viscosity parameter d, and the imaginary inertia parameter m.

Subsequently, the display control section 51 displays a detected waveform L based on the force f_{S}, which the acquiring section 55 causes the storage medium to store in step S480, on the graph G1 together with the setting value selected in step S470, that is, setting value identification information indicating the setting values associated with the detected waveform L (step S490). Specifically, the display control section 51 reads out the force f_{S} at every sampling cycle from the storage medium. The display control section 51 displays, on the graph G1, the detected waveform L, which is a time series waveform of the read-out force f_{S}. That is, the detected waveform L is a time response waveform of the force f_{S} serving as the output value of the force detecting section 21. In this example, the vertical axis and the horizontal axis of the graph G1 have scales same as the scales of the vertical axis and the horizontal axis of the graph G2. The detected waveform L is a waveform that converges on the target force f_{St} having the magnitude received in the input window N1. Note that the vertical axis and the horizontal axis of the graph G1 may be scales different from the scales of the vertical axis and the horizontal axis of the graph G2 instead of having the scales same as the scales of the vertical axis and the horizontal axis of the graph G2.

In this way, by repeatedly performing the processing in steps S470 to S490 for the respective one or more setting values specified in step S460, the display control section 51 displays, on the graph G1, one or more detected waveforms L and setting value identification information corresponding to the detected waveforms L. Consequently, the teaching device 50 can cause, according to operation performed once, the arm A to perform the first motion by the number of setting values. Therefore, it is possible to reduce time required to select a setting value desired by the user. In the example shown in FIG. 16, as an example, the kinds of setting value identification information SR1 to SR6, which are the six kinds of setting value identification information, are displayed on the graph G1. Checkboxes are associated with the respective kinds of setting value identification information SR1 to SR6.

By selecting (performing selection operation for, for example, tapping or clicking) one or more checkboxes out of the checkboxes displayed on the graph G1, the user can select kinds of setting value identification information associated with the respective selected one or more checkboxes. The user can display, on the graph G1, the detected waveforms L associated with the respective selected one or more kinds of setting value identification information.

That is, the display control section 51 specifies, on the basis of operation received from the user, one or more checkboxes desired by the user on the graph G1. The display control section 51 specifies kinds of setting value identification information associated with the respective specified one or more checkboxes. The display control section 51 specifies, as one or more detected waveforms L desired by the user, the detected waveforms L associated with the respective specified one or more kinds of setting value identification information. The display control section 51 displays the specified one or more detected waveforms L on the graph G1. Consequently, the teaching device 50 can cause the user to easily visually recognize how the detected waveforms L change when the setting values are changed and can cause the user to easily compare the change of the detected waveforms L at the time when the setting values are changed.

In the example shown in FIG. 16, the user selects the checkboxes associated with the respective kinds of setting value identification information SR1 to SR5. Therefore, on the graph G1 shown in FIG. 16, the detected waveforms L associated with the respective kinds of setting value identification information SR1 to SR5 are displayed.

Subsequently, the receiving section 53 receives setting value identification information indicating a setting value desired by the user (step S500). That is, the receiving section 53 receives setting value identification information associated with the detected waveform L desired by the user. The main screen includes the input window N4 for receiving the setting value identification information associated with the setting value desired by the user. The receiving section 53 receives, in the input window N4, an input of the setting value identification information associated with the setting value desired by the user. In the example shown in FIG. 16, the setting value identification information SR1 is input to the input window N4.

Subsequently, the receiving section 53 determines whether the button B2, which is a determination button, is operated (step S510). That is, the receiving section 53 determines whether operation for determining, as the setting value identification information indicating the setting value desired by the user, the setting value identification information received in the input window N4 is received.

When determining that the button B2 is not operated (NO in step S510), the receiving section 53 shifts to step S500 and receives setting value identification information indicating the setting value desired by the user again. That is, determining that the user dissatisfies with the detected waveform L associated with the setting value identification information input to the input window N4, the receiving section continues to receive setting value identification information indicating a setting value desired by the user. On the other hand, when the receiving section 53 determines that the button B2 is operated (YES in step S510), the setting section 54 specifies, as the setting value desired by the user, a setting value indicated by the setting value identification information received in the input window N4. The setting section 54 causes the storage medium of the teaching device 50 to store, in association with the specified setting value and the imaginary elasticity parameter k received in the input window N3, the detected waveform L associated with the setting value identification information indicating the setting value as the stored waveform V, outputs the setting value and the imaginary elasticity parameter k to the robot control device 30 and causes the robot control device 30 to store the setting value and the imaginary elasticity parameter k (step S520), and ends the processing. Consequently, the teaching device 50 can cause the robot control device 30 to store (can teach the robot control device 30 about) the imaginary elasticity parameter k, the imaginary viscosity parameter d, and the imaginary inertia parameter m, which are parameters of the impedance control, together with the target force f_{St} set on the main screen. The teaching device 50 can cause the user to easily compare the detected wave L stored in the storage medium in the past as the stored wave V and the detected waveform L displayed on the output device anew. As a result, the teaching device 50 can reduce time required by the user to select a desired setting value.

Note that, in step S510, the setting section 54 may set, in the robot control section 52, the setting value indicated by the setting value identification information received in the input window N4. In this case, after the setting value is set in the robot control section 52, the robot control section 52 causes the arm A to perform a predetermined second motion on the basis of the set setting value. The predetermined second motion may be a motion same as the first motion or may be a motion different from the first motion. For example, the second motion may be a motion same as a motion of the arm A at the time when the robot control device 30 causes the arm A to perform some work. When the second motion is this motion, the user can check, without directly operating the robot control device 30, the behavior of the arm A at the time when the arm A is controlled by the robot control device 30 according to the setting value selected by the user.

### Modifications of the Embodiments

Modifications of the embodiments are explained below.

The receiving section 53 may receive a reference value of a behavior value with one of the slider H1 and the slider H2 on the slider bar H on the main screen. In this case, the receiving section 53 determines an upper limit value and a lower limit value of the behavior value on the basis of the reference value. For example, the receiving section 53 may determine, as the lower limit value, a behavior value smaller than the reference value by a predetermined value and determine, as the upper limit value, a behavior value larger than the reference value by the value, may determine the reference value as the lower limit value of the behavior value and determine, as the upper limit value of the behavior value, a behavior value larger than the reference value by a predetermined value, may determine the reference value as the upper limit value of the behavior value and determine, as the lower limit value of the behavior value, a behavior value smaller than the reference value by a predetermined value, or may determine the upper limit value and the lower limit value on the basis of the reference value.

The display control section 51 may display, on the one or more detected waveforms L displayed on the graph G1, a part or all of the one or more stored waveforms V displayed on the graph G2. In this case, the display control section 51 displays the stored waveforms V and the detected waveforms L on the graph G2 using colors or line types that can be identified from each other. For example, the display control section 51 displays the stored waveforms Von the graph G2 using dotted lines and displays the detected waveforms L on the graph G2 using solid lines.

The display control section 51 may display, on the one or more stored waveforms V displayed on the graph G2, a part or all of the one or more detected waveforms L displayed on the graph G1. In this case, the display control section 51 displays the stored waveforms V and the detected waveforms L on the graph G1 using colors or line types that can be identified from each other. For example, the display control section 51 displays the stored waveforms V on the graph G1 using dotted lines and displays the detected waveforms L on the graph G1 using solid lines.

When displaying two or more stored waveforms V on the graph G2, the display control section 51 may display the respective two or more stored waveforms Von the graph G2 using colors or line types different from each other.

When displaying two or more detected waveforms L, the display control section 51 may display the respective two or more detected waveforms L on the graph G1 using colors or line types different from each other.

When displaying two or more detected waveforms L on the graph G1, the display control section 51 may set, as a reference waveform, the detected waveform L selected by the user among the two or more detected waveforms L and display, on the graph G1, using colors or line types that can be identified from each other, the detected waveforms L including crest values larger than a maximum crest value included in the reference waveform and the detected waveforms L including only crest values smaller than the maximum crest value included in the reference waveform. For example, among the two or more detected waveforms L, the display control section 51 displays, using solid lines, the detected waveforms L including the crest values larger than the maximum crest value included in the reference waveform and displays, using dotted lines, the detected waveforms L including only the crest values smaller than the maximum crest values included in the reference waveform.

The display control section 51 may display, on the main screen, details of parameters using tooltips or the like. For example, when a cursor of a mouse is placed on one of one or more detected waveforms L on the graph G1, the display control section 51 displays, on the main screen, using a tooltip, a setting value indicated by setting value identification information associated with the detected waveform L on which the cursor is placed. When the cursor of the mouse is placed on one of one or more stored waveforms V on the graph G2, the display control section 51 displays, on the main screen, using a tooltip, a parameter indicated by parameter identification information associated with the stored waveform V on which the cursor is placed.

As explained above, the control device 28 acquires an output value of the force detecting section at the time when the control device 28 causes the robot (in this example, the robot 26) including the force detecting section (in this example, the force detecting section 21) to operate on the basis of a predetermined setting value, causes the robot to perform, for a respective plurality of setting values, a predetermined first motion on the basis of the setting values, causes the display section (in this example, the not-shown output device) to display time response waveforms of the acquired output value, the time response waveforms being time response waveforms for the respective setting values, and selects, on the basis of operation received from the user, a time response waveform desired by the user out of the time response waveforms for the respective setting values displayed on the display section. Consequently, the control device 28 can operate the robot on the basis of a setting value corresponding to the time response waveform desired by the user.

The control device 28 causes, on the basis of operation received from the user, the display section to display a part or all of the time response waveforms for the respective setting values. Consequently, the control device 28 can cause the user to select a setting value corresponding to a time response waveform desired by the user out of a part or all of the time response waveforms for the respective setting values.

The control device 28 causes, on the basis of operation received from the user, the display section to display a part or all of time response waveforms stored in the storing section (in this example, the not-shown storage medium of the teaching device 50) in advance. Consequently, the control device 28 can cause the user to select a setting value corresponding to a time response waveform desired by the user out of a part or all of the time response waveforms stored in the storing section.

The control device 28 specifies a respective plurality of setting values on the basis of operation received from the user and performs, for the respective specified setting values, the compliant motion control based on the setting values and an output value of the force detecting section. Consequently, the control device 28 can operate the robot on the basis of a setting value corresponding to a time response waveform desired by the user among time response waveforms of the output value of the force detecting section, which are results of compliant motion control performed for the respective specified setting values.

The control device 28 specifies a plurality of setting values on the basis of operation received from the user, the plurality of setting values being respective setting values including at least one of imaginary inertia parameters, imaginary elasticity parameters, and imaginary viscosity parameters and performs, for the respective specified setting values, the impedance control based on the setting values and an output value of the force detecting section. Consequently, the control device 28 can operate the robot on the basis of a setting values corresponding to a time response waveforms desired by the user among time response waveforms of the output value of the force detecting section in the impedance control performed for the respective specified setting values.

The control device 28 causes the robot to perform, for respective setting values, the number of which is determined in advance or input by the user, the predetermined first motion on the basis of the setting values. Consequently, the control device 28 can cause the user to select a setting value corresponding to a time response waveform desired by the user out of time response waveforms for the respective setting values, the number of which is determined in advance or input by the user.

The control device 28 sets a setting value associated with a time response waveform corresponding to received operation and causes the robot to perform the predetermined second motion on the basis of the set setting value. Consequently, the control device 28 can cause the robot to perform work including the second motion, which is a motion desired by the user.

The embodiments of the invention are explained in detail above with reference to the drawings. However, a specific configuration is not limited to the embodiments and may be, for example, changed, substituted, or deleted without departing from the spirit of the invention.

It is also possible to record, in a computer-readable recording medium, a computer program for realizing functions of any components in the devices (e.g., the robot control device 30, the teaching device 50, and the information processing device 40) explained above, cause a computer system to read the computer program, and execute the computer program. Note that the “computer system” includes an OS (an operating system) and hardware such as peripheral devices. The “computer-readable recording medium” refers to a portable medium such as a flexible disk, a magneto-optical disk, a ROM, or a CD (Compact Disk)-ROM or a storage device such as a hard disk incorporated in the computer system. Further, the “computer-readable recording medium” includes a recording medium that stores a computer program for a fixed time such as a volatile memory (a RAM) inside a computer system functioning as a server or a client when a computer program is transmitted via a network such as the Internet or a communication line such as a telephone line.

The computer program may be transmitted from a computer system, which stores the computer program in a storage device or the like, to another computer system via a transmission medium or by a transmission wave in the transmission medium. The “transmission medium”, which transmits the computer program, refers to a medium having a function of transmitting information like a network (a communication network) such as the Internet or a communication line (a communication wire) such as a telephone line.

The computer program may be a computer program for realizing a part of the functions explained above. Further, the computer program may be a computer program that can realize the functions in a combination with a computer program already recorded in the computer system, a so-called differential file (a differential program).

The entire disclosure of Japanese Patent Application Nos. 2016-049271, filed Mar. 14, 2016, and 2016-047951, field Mar. 11, 2016 are expressly incorporated by reference herein.

What is claimed is:

1. A robot control device comprising:
a robot control section that controls a robot, wherein
the robot control device outputs, to another device, second information associated with first information indicating operation being executed by the robot control section, the operation being operation for causing the robot to perform work.

2. The robot control device according to claim 1, wherein the second information includes information indicating a control amount for controlling the robot.

3. The robot control device according to claim 1, wherein the second information includes information indicating a physical quantity representing an operation state of the robot.

4. The robot control device according to claim 2, further comprising a force-detection-information acquiring section that acquires force detection information from a force detecting section, wherein the second information includes information indicating a physical quantity representing an operation state of the robot.

5. The robot control device according to claim 3, further comprising a force-detection-information acquiring section that acquires force detection information from a force detecting section, wherein the information indicating the physical quantity representing the operation state of the robot includes the force detection information.

6. The robot control device according to claim 4, wherein the information indicating the physical quantity representing the operation state of the robot includes the force detection information.

7. A robot system comprising:
the robot control device according to claim 1; and
a robot controlled by the robot control device.

8. A robot system comprising:
the robot control device according to claim 2; and
a robot controlled by the robot control device.

9. A robot system comprising:
the robot control device according to claim 3; and
a robot controlled by the robot control device.

10. A robot system comprising:
the robot control device according to claim 4; and
a robot controlled by the robot control device.

11. A robot system comprising:
the robot control device according to claim 5; and
a robot controlled by the robot control device.

12. A robot system comprising:
the robot control device according to claim 6; and
a robot controlled by the robot control device.
